(19) United States
(12) Patent Application Publication
(10) Pub. No.: US 2022/0099923 A1
(43) Pub. Date: Mar. 31, 2022

(54) FOUR-PIECE INFRARED SINGLE WAVELENGTH PROJECTION LENS SYSTEM

(71) Applicant: NEWMAX TECHNOLOGY CO., LTD., TAICHUNG CITY (TW)

(72) Inventors: CHING-YUN HUANG, TAICHUNG CITY (TW); Chi-Chang WANG, TAICHUNG CITY (TW)

(21) Appl. No.: 17/035,678

(22) Filed: Sep. 28, 2020

(51) Int. Cl. G02B 9/36; G02B 13/00; G02B 3/04

(52) U.S. Cl. CPC G02B 9/36; G02B 3/04; G02B 13/004

(57) ABSTRACT

A four-piece infrared single wavelength projection lens system includes, in order from an image side to an image source side: a first lens element with a refractive power and made of glass material; a second lens element with a refractive power; a third lens element with a refractive power; and a fourth lens element with a positive refractive power, wherein a focal length of the second lens element is f2, a central thickness of the second lens element along an optical axis is CT2, and they satisfy the relation: −28<f2/CT2<161. Such a system has a larger focal length, high resolution, short length, less distortion.

### BACKGROUND

### Field of the Invention

The present invention relates to a lens system, and more particularly to a miniaturized four-piece infrared single wavelength projection lens system applicable to electronic products.

### Description of the Prior Art

Nowadays digital imaging technology is constantly innovating and changing, in particular, digital carriers, such as, digital camera and mobile phone and so on, have become smaller in size, so CCD (Charge Coupled Device) or CMOS (Complementary Metal Oxide Semiconductor) sensor is also required to be more compact. In addition to be used in the field of photography, in recent years, infrared focusing lens has also be used in infrared receiving and sensing field of the game machine, and in order to make the scope of game machine induction user more broader, wide-angle lens group has become the mainstream for receiving infrared wavelength at present.

The applicant has also put forward a number of lens groups related to infrared wavelength reception, however, at present, the game machine is based on a more three-dimensional, real and immediate 3D game, the current or the applicant's previous lens groups are all 2D plane games, which cannot meet the 3D game focusing on the deep induction efficacy.

Special infrared receiving and induction lens groups for game machines are made of plastic for the pursuit of low cost, however, poor material transparency is one of the key factors that affect the depth detection accuracy of the game machine, and plastic lenses are easy to overheat or too cold in ambient temperature, so that the focal length of the lens group will be changed and cannot focus accurately. Therefore, the current infrared receiving and induction lens groups cannot meet the 3D game depth precise induction requirement.

The present invention mitigates and/or obviates the aforementioned disadvantages.

### SUMMARY

The primary objective of the present invention is to provide a four-piece infrared single wavelength projection lens system which has a larger focal length, high resolution, short length and less distortion.

Therefore, a four-piece infrared single wavelength projection lens system in accordance with the present invention comprises a stop and a lens group having four lens elements, in order from an image side to an image source side:

the stop; a first lens element with a refractive power having an image-side surface being convex near an optical axis, at least one of the image-side surface and an image source-side surface of the first lens element being aspheric, the first lens element is made of glass material; a second lens element with a refractive power having an image-side surface being convex near the optical axis and an image source-side surface being concave near the optical axis, at least one of the image-side surface and the image source-side surface of the second lens element being aspheric; a third lens element with a refractive power having an image-side surface being concave near the optical axis, at least one of the image-side surface and an image source-side surface of the third lens element being aspheric; and a fourth lens element with a positive refractive power having an image source-side surface being convex near the optical axis, at least one of an image-side surface and the image source-side surface of the fourth lens element being aspheric.

Wherein a focal length of the second lens element is f2, a central thickness of the second lens element along the optical axis is CT2, and they satisfy the relation: −28<f2/CT2<161, so that the lens interior space can be used effectively to achieve the objective of miniaturization of the lens element.

Preferably, the focal length of the second lens element is f2, a focal length of the third lens element is f3, and they satisfy the relation: −45<f2/f3<10, which can improve the peripheral resolution and illuminance of the system.

Preferably, a radius of curvature of the image-side surface of the fourth lens element is R7, a distance along the optical axis between the third lens element and the fourth lens element is T34, and they satisfy the relation: −63<R7/T34<192, so that the mirror spacing can be shortened to achieve the objective of miniaturization of the lens elements.

Preferably, the four-piece infrared single wavelength projection lens system has a maximum view angle (field of view) FOV, and it satisfies the relation: FOV<36, which is favorable to concentrate the beam projection and increase the illumination of the projection surface, thus improving the quality.

Preferably, a focal length of the first lens element is f1, the focal length of the second lens element is f2, and they satisfy the relation: −3<f1/f2<1, so that the refractive power of the first lens element and the second lens element are more suitable, it will be favorable to avoid the excessive increase of aberration of the system.

Preferably, the focal length of the third lens element is f3, a focal length of the fourth lens element is f4, and they satisfy the relation: −2<f3/f4<0.1, so that the refractive power of the system can be balanced effectively, it will be favorable to reduce the sensitivity of the system, improving the yield of production.

Preferably, the focal length of the second lens element is f2, a focal length of the second lens element and the third lens element combined is f23, and they satisfy the relation: −38<f2/f23<10, so that the refractive powers of the lens elements can be adjusted, which is favorable to correct the aberration, reduce the total track length and adjust the field of view.

Preferably, the focal length of the second lens element is f2, a focal length of the first lens element and the second lens element combined is f12, and they satisfy the relation: −8.5<f2/f12<32, so that the resolution can be improved evidently.

Preferably, the focal length of the first lens element is f1, a focal length of the third lens element and the fourth lens element combined is f34, and they satisfy the relation: −2.2<f1/f34<1.1, so that the refractive powers of the lens elements can be adjusted, which is favorable to correct the aberration, reduce the total track length and adjust the field of view.

Preferably, the focal length of the second lens element and the third lens element combined is f23, a focal length of the four-piece infrared single wavelength projection lens system is f, and they satisfy the relation: −1.5<f23/f<0.75, so that the refractive powers of the lens elements can be adjusted, which is favorable to correct the aberration, reduce the total track length and adjust the field of view.

Preferably, the focal length of the second lens element is f2, a distance from the image-side surface of the first lens element to an image source plane along the optical axis is TL, and they satisfy the relation: −5<f2/TL<21, it will be favorable to maintain the objective of miniaturization and larger focal length of the four-piece infrared single wavelength projection lens system, which can be used in thin electronic products.

Preferably, a radius of curvature of the image source-side surface of the first lens element is R2, a central thickness of the first lens element along the optical axis is CT1, and they satisfy the relation: −5<R2/CT1<26, which is favorable to the lens formability.

Preferably, a radius of curvature of the image-side surface of the second lens element is R3, a distance along the optical axis between the first lens element and the second lens element is T12, and they satisfy the relation: 40<R3/T12<136, so that the mirror spacing can be shortened to achieve the objective of miniaturization of the lens elements.

Preferably, a radius of curvature of the image source-side surface of the third lens element is R6, the focal length of the third lens element is f3, and they satisfy the relation: −5<R6/f3<3, which is favorable to the correction of the high order aberrations and astigmatism of the system.

Preferably, the radius of curvature of the image-side surface of the fourth lens element is R7, the focal length of the third lens element and the fourth lens element combined is f34, and they satisfy the relation: −10<R7/f34<5.5, which is favorable to the lens formability.

Preferably, a distance along the optical axis between the second lens element and the third lens element is T23, a central thickness of the third lens element along the optical axis is CT3, and they satisfy the relation: 0.4<T23/CT3<2.8, which can adjust the lens thickness and lens spacing, so as to reduce the effect of manufacturing tolerance on image quality.

Preferably, the distance along the optical axis between the third lens element and the fourth lens element is T34, a central thickness of the fourth lens element along the optical axis is CT4, and they satisfy the relation: 0.04<T34/CT4<1.1, which can adjust the lens thickness and lens spacing, so as to reduce the effect of manufacturing tolerance on image quality.

Preferably, the focal length of the four-piece infrared single wavelength projection lens system is f, the focal length of the second lens element is f2, and they satisfy the relation: −1.5<f/f2<1.9, which ensures that the lens system has sufficient refractive power to shorten the lens length.

Preferably, the radius of curvature of the image source-side surface of the first lens element is R2, the radius of curvature of the image source-side surface of the third lens element is R6, and they satisfy the relation: −5<R2/R6<2.5, so that the curvature of each lens element can be balanced to increase the lens formability.

Preferably, the radius of curvature of the image-side surface of the fourth lens element is R7, the central thickness of the fourth lens element along the optical axis is CT4, and they satisfy the relation: −32<R7/CT4<17, which is favorable to the lens formability.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A shows a four-piece infrared single wavelength projection lens system in accordance with a first embodiment of the present invention;

FIG. 1B shows the image plane curve and the distortion curve of the first embodiment of the present invention;

FIG. 2A shows a four-piece infrared single wavelength projection lens system in accordance with a second embodiment of the present invention;

FIG. 2B shows the image plane curve and the distortion curve of the second embodiment of the present invention;

FIG. 3A shows a four-piece infrared single wavelength projection lens system in accordance with a third embodiment of the present invention;

FIG. 3B shows the image plane curve and the distortion curve of the third embodiment of the present invention;

FIG. 4A shows a four-piece infrared single wavelength projection lens system in accordance with a fourth embodiment of the present invention;

FIG. 4B shows the image plane curve and the distortion curve of the fourth embodiment of the present invention;

FIG. 5A shows a four-piece infrared single wavelength projection lens system in accordance with a fifth embodiment of the present invention;

FIG. 5B shows the image plane curve and the distortion curve of the fifth embodiment of the present invention;

FIG. 6A shows a four-piece infrared single wavelength projection lens system in accordance with a sixth embodiment of the present invention;

FIG. 6B shows the image plane curve and the distortion curve of the sixth embodiment of the present invention;

FIG. 7A shows a four-piece infrared single wavelength projection lens system in accordance with a seventh embodiment of the present invention;

FIG. 7B shows the image plane curve and the distortion curve of the seventh embodiment of the present invention;

FIG. 8A shows a four-piece infrared single wavelength projection lens system in accordance with an eighth embodiment of the present invention;

FIG. 8B shows the image plane curve and the distortion curve of the eighth embodiment of the present invention;

FIG. 9A shows a four-piece infrared single wavelength projection lens system in accordance with a ninth embodiment of the present invention; and

FIG. 9B shows the image plane curve and the distortion curve of the ninth embodiment of the present invention.

### DETAILED DESCRIPTION

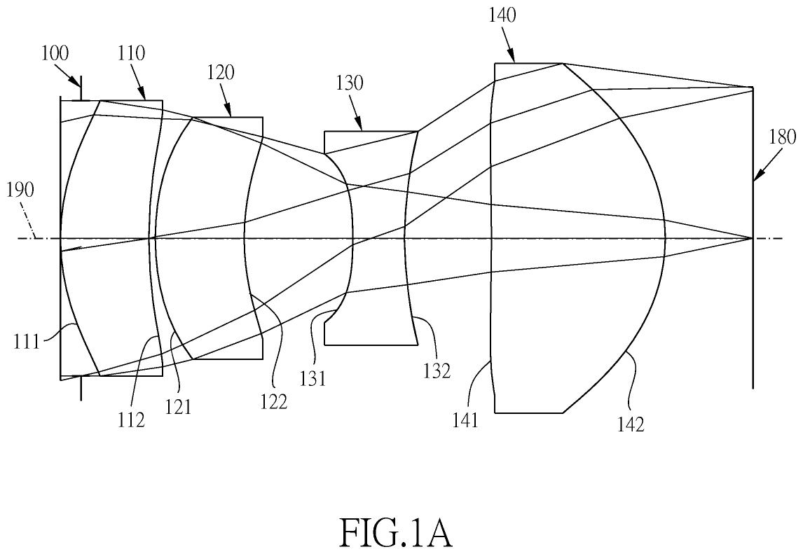

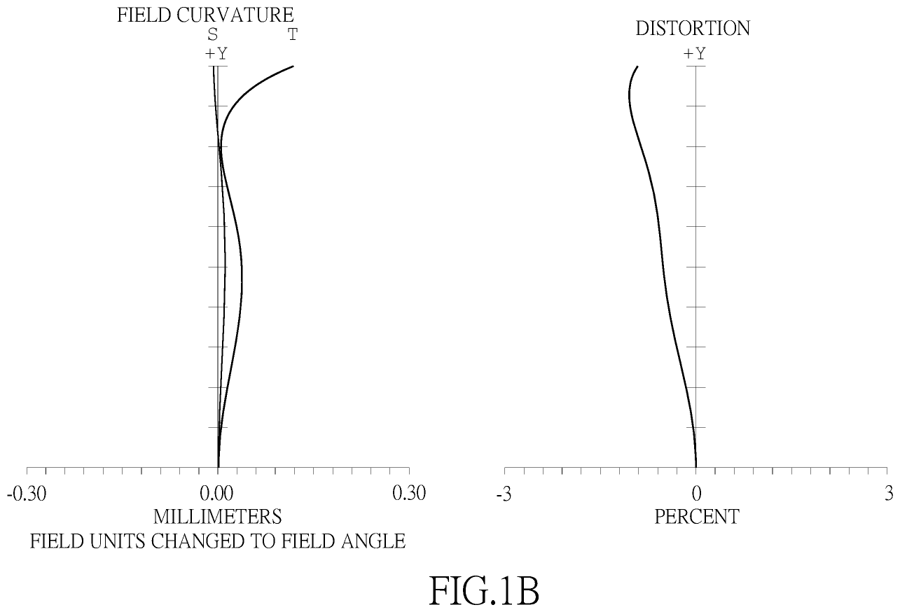

Referring to FIGS. 1A and 1B, FIG. 1A shows a four-piece infrared single wavelength projection lens system in accordance with a first embodiment of the present invention, and FIG. 1B shows, in order from left to right, the image plane curve and the distortion curve of the first embodiment of the present invention. A four-piece infrared single wavelength projection lens system in accordance with the first embodiment of the present invention comprises a stop 100 and a lens group. The lens group comprises, in order from an image side to an image source side: a first lens element 110, a second lens element 120, a third lens element 130, a fourth lens element 140 and an image source plane 180, wherein the four-piece infrared single wavelength projection lens system has a total of four lens elements with refractive power. The stop 100 is disposed between an object to be projected and an image source-side surface 112 of the first lens element 110. The four-piece infrared single wavelength projection lens system can project the light on the image source plane 180 of the image source side to the object to be projected on the image side.

The first lens element 110 with a positive refractive power has an image-side surface 111 being convex near an optical axis 190 and the image source-side surface 112 being concave near the optical axis 190, the image-side surface 111 and the image source-side surface 112 are aspheric, and the first lens element 110 is made of glass.

The second lens element 120 with a positive refractive power has an image-side surface 121 being convex near the optical axis 190 and an image source-side surface 122 being concave near the optical axis 190, the image-side surface 121 and the image source-side surface 122 are aspheric, and the second lens element 120 is made of plastic material.

The third lens element 130 with a negative refractive power has an image-side surface 131 being concave near the optical axis 190 and an image source-side surface 132 being concave near the optical axis 190, the image-side surface 131 and the image source-side surface 132 are aspheric, and the third lens element 130 is made of plastic material.

The fourth lens element 140 with a positive refractive power has an image-side surface 141 being concave near the optical axis 190 and an image source-side surface 142 being convex near the optical axis 190, the image-side surface 141 and the image source-side surface 142 are aspheric, and the fourth lens element 140 is made of plastic material.

The equation for the aspheric surface profiles of the respective lens elements of the first embodiment is expressed as follows:

$$z = \frac{{ch}^{2}}{1 + {[ 1 - ( k + 1 ) {c}^{2} {h}^{2} ]}^{0.5}} + {Ah}^{4} + {Bh}^{6} + {Ch}^{8} + {Dh}^{10} + {Eh}^{12} + {Fh}^{14} + {Gh}^{16} …$$

wherein:

z represents the value of a reference position with respect to a vertex of the surface of a lens and a position with a height h along the optical axis 190;

c represents a paraxial curvature equal to 1/R (R: a paraxial radius of curvature);

h represents a vertical distance from the point on the curve of the aspheric surface to the optical axis 190;

k represents the conic constant;

A, B, C, D, E, F, . . . : represent the high-order aspheric coefficients.

In the first embodiment of the present four-piece infrared single wavelength projection lens system, a focal length of the four-piece infrared single wavelength projection lens system is f, a f-number of the four-piece infrared single wavelength projection lens system is Fno, the four-piece infrared single wavelength projection lens system has a maximum view angle (field of view) FOV, and they satisfy the relations: f=3.92 mm; Fno=2.3; and FOV=27.4 degrees.

In the first embodiment of the present four-piece infrared single wavelength projection lens system, a focal length of the second lens element 120 is f2, a central thickness of the second lens element 120 along the optical axis 190 is CT2, and they satisfy the relation: f2/CT2=160.7.

In the first embodiment of the present four-piece infrared single wavelength projection lens system, the focal length of the second lens element 120 is f2, a focal length of the third lens element 130 is f3, and they satisfy the relation: f2/f3=−43.76.

In the first embodiment of the present four-piece infrared single wavelength projection lens system, a radius of curvature of the image-side surface 141 of the fourth lens element 140 is R7, a distance along the optical axis 190 between the third lens element 130 and the fourth lens element 140 is T34, and they satisfy the relation: R7/T34=−61.36.

In the first embodiment of the present four-piece infrared single wavelength projection lens system, a focal length of the first lens element 110 is f1, the focal length of the second lens element 120 is f2, and they satisfy the relation: f1/f2=0.04.

In the first embodiment of the present four-piece infrared single wavelength projection lens system, the focal length of the third lens element 130 is f3, a focal length of the fourth lens element 140 is f4, and they satisfy the relation: f3/f4=−0.95.

In the first embodiment of the present four-piece infrared single wavelength projection lens system, the focal length of the second lens element 120 is f2, a focal length of the second lens element 120 and the third lens element 130 combined is f23, and they satisfy the relation: f2/f23=−37.43.

In the first embodiment of the present four-piece infrared single wavelength projection lens system, the focal length of the second lens element 120 is f2, a focal length of the first lens element 110 and the second lens element 120 combined is f12, and they satisfy the relation: f2/f12=31.63.

In the first embodiment of the present four-piece infrared single wavelength projection lens system, the focal length of the first lens element 110 is f1, a focal length of the third lens element 130 and the fourth lens element 140 combined is f34, and they satisfy the relation: f1/f34=0.91.

In the first embodiment of the present four-piece infrared single wavelength projection lens system, the focal length of the second lens element 120 and the third lens element 130 combined is f23, the focal length of the four-piece infrared single wavelength projection lens system is f, and they satisfy the relation: f23/f=−0.56.

In the first embodiment of the present four-piece infrared single wavelength projection lens system, the focal length of the second lens element 120 is f2, a distance from the image-side surface 111 of the first lens element 110 to the image source plane 180 along the optical axis 190 is TL, and they satisfy the relation: f2/TL=20.63.

In the first embodiment of the present four-piece infrared single wavelength projection lens system, a radius of curvature of the image source-side 112 surface of the first lens element 110 is R2, a central thickness of the first lens element 110 along the optical axis 190 is CT1, and they satisfy the relation: R2/CT1=6.51.

In the first embodiment of the present four-piece infrared single wavelength projection lens system, a radius of curvature of the image-side surface 121 of the second lens element 120 is R3, a distance along the optical axis 190 between the first lens element 110 and the second lens element 120 is T12, and they satisfy the relation: R3/T12=48.18.

In the first embodiment of the present four-piece infrared single wavelength projection lens system, a radius of curvature of the image source-side surface 132 of the third lens element 130 is R6, the focal length of the third lens element 130 is f3, and they satisfy the relation: R6/f3=−1.10.

In the first embodiment of the present four-piece infrared single wavelength projection lens system, the radius of curvature of the image-side surface 141 of the fourth lens element 140 is R7, the focal length of the third lens element 130 and the fourth lens element 140 combined is f34, and they satisfy the relation: R7/f34=−9.31.

In the first embodiment of the present four-piece infrared single wavelength projection lens system, a distance along the optical axis 190 between the second lens element 120 and the third lens element 130 is T23, a central thickness of the third lens element 130 along the optical axis 190 is CT3, and they satisfy the relation: T23/CT3=2.10.

In the first embodiment of the present four-piece infrared single wavelength projection lens system, the distance along the optical axis 190 between the third lens element 130 and the fourth lens element 140 is T34, a central thickness of the fourth lens element 140 along the optical axis 190 is CT4, and they satisfy the relation: T34/CT4=0.50.

In the first embodiment of the present four-piece infrared single wavelength projection lens system, the focal length of the four-piece infrared single wavelength projection lens system is f, the focal length of the second lens element 120 is f2, and they satisfy the relation: f/f2=0.05.

In the first embodiment of the present four-piece infrared single wavelength projection lens system, the radius of curvature of the image source-side 112 surface of the first lens element 110 is R2, the radius of curvature of the image source-side surface 132 of the third lens element 130 is R6, and they satisfy the relation: R2/R6=1.61.

In the first embodiment of the present four-piece infrared single wavelength projection lens system, the radius of curvature of the image-side surface 141 of the fourth lens element 140 is R7, the central thickness of the fourth lens element 140 along the optical axis 190 is CT4, and they satisfy the relation: R7/CT4=−30.75.

The detailed optical data of the first embodiment is shown in table 1, and the aspheric surface data is shown in table 2.

TABLE 1
Embodiment 1
F(focal length) = 3.92 mm, Fno = 2.3, FOV = 27.4 deg.

| | | | | | | | | Focal |
|---|---|---|---|---|---|---|---|---|
| surface | | Curvature Radius | | Thickness | Material | Index | Abbe # | length |
| 0 | object | plane | | 1000 | | | | |
| 1 | | plane | | 0.119 | | | | |
| 2 | stop | plane | | −0.119 | | | | |
| 3 | Lens 1 | 1.483 | (ASP) | 0.512 | glass | 1.81 | 40.7 | 3.01 |
| 4 | | 3.334 | (ASP) | 0.036 | | | | |
| 5 | Lens 2 | 1.745 | (ASP) | 0.514 | plastic | 1.64 | 22.5 | 82.59 |
| 6 | | 1.602 | (ASP) | 0.627 | | | | |
| 7 | Lens 3 | −2.854 | (ASP) | 0.298 | plastic | 1.64 | 22.5 | −1.89 |
| 8 | | 2.069 | (ASP) | 0.503 | | | | |
| 9 | Lens 4 | −30.863 | (ASP) | 1.004 | plastic | 1.64 | 22.5 | 1.98 |
| 10 | | −1.195 | (ASP) | 0.509 | | | | |

| | | |
|---|---|---|
| 11 | Image | plane |
| | source | |
| | plane | |

TABLE 2
Aspheric Coefficients

| surface | 3 | 4 | 5 | 6 |
|---|---|---|---|---|
| K: | −6.5895E−01 | 2.6145E−01 | 1.6802E+00 | −9.4364E+00 |
| A: | −1.1944E−02 | −4.0575E−02 | −1.3926E−02 | 1.2144E−01 |
| B: | −5.9641E−04 | 3.5028E−01 | 5.2253E−01 | −1.1677E−01 |
| C: | −7.6763E−02 | −1.1237E+00 | −1.0518E+00 | 7.6033E−01 |
| D: | −1.1796E−02 | 1.3840E+00 | 1.2859E+00 | −2.8366E+00 |
| E: | −2.2458E−04 | −1.0441E+00 | −1.4736E+00 | 7.4634E−01 |
| F: | 1.2445E−01 | 4.1759E−01 | 1.0749E+00 | 6.5787E−01 |
| G: | −1.2793E−01 | −5.6927E−02 | −5.2051E−01 | 1.4565E+00 |
| surface | 7 | 8 | 9 | 10 |
| K: | 2.3178E+01 | −2.5493E+01 | −5.2393E+01 | −7.3000E−01 |
| A: | −1.1809E+00 | −5.0547E−02 | −4.7599E−02 | −1.2158E−01 |
| B: | 4.0885E−01 | −1.6138E+00 | 1.5822E−01 | 2.2334E−01 |
| C: | −5.0509E+00 | 1.3034E+01 | −3.3982E−02 | −2.9995E−01 |
| D: | 5.2538E+01 | −3.2545E+01 | −2.1417E−01 | 1.7014E−01 |
| E: | −2.3390E+02 | 1.9637E+01 | 2.8913E−01 | 2.5936E−02 |
| F: | 8.2560E+01 | 4.1621E+01 | −1.1127E−01 | −8.2018E−02 |
| G: | 8.0287E+02 | −5.3843E+01 | −1.8997E−03 | 3.4124E−02 |

The units of the radius of curvature, the thickness and the focal length in table 1 are expressed in mm, the surface numbers 0-11 represent the surfaces sequentially arranged from the image-side to the image source-side along the optical axis. In table 2, k represents the conic coefficient of the equation of the aspheric surface profiles, and A, B, C, D, E, F . . . : represent the high-order aspheric coefficients. The tables presented below for each embodiment are the corresponding schematic parameter, aberration curves, and the definitions of the tables are the same as Table 1 and Table 2 of the first embodiment. Therefore, an explanation in this regard will not be provided again.

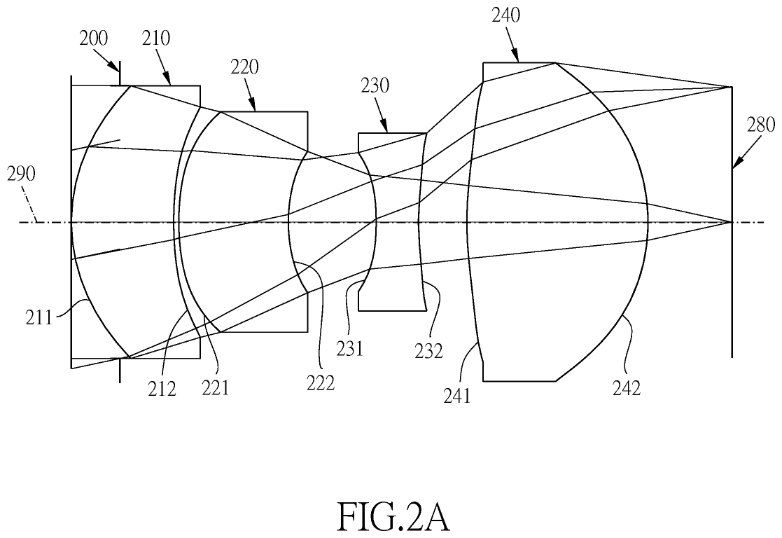

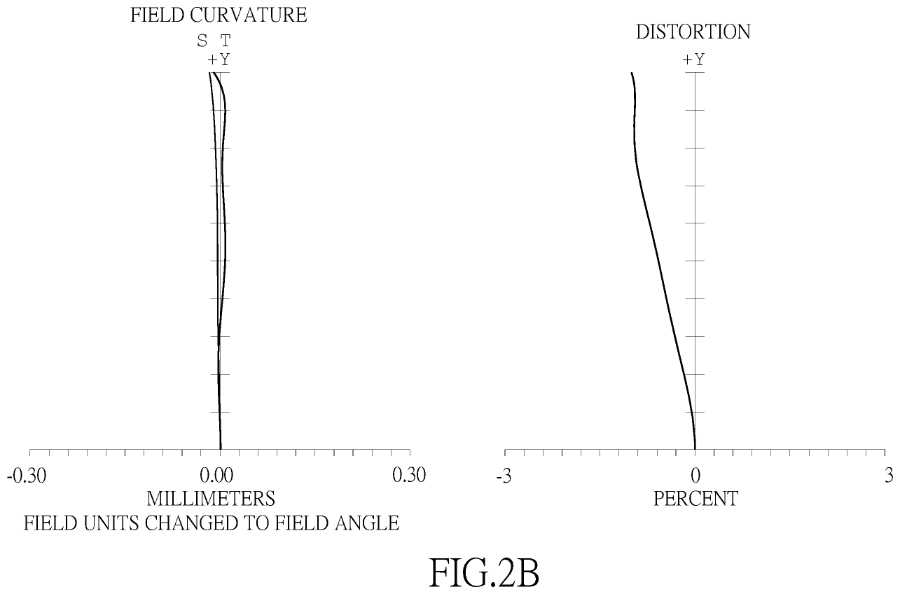

Referring to FIGS. 2A and 2B, FIG. 2A shows a four-piece infrared single wavelength projection lens system in accordance with a second embodiment of the present invention, and FIG. 2B shows, in order from left to right, the image plane curve and the distortion curve of the second embodiment of the present invention. A four-piece infrared single wavelength projection lens system in accordance with the second embodiment of the present invention comprises a stop 200 and a lens group. The lens group comprises, in order from an image side to an image source side: a first lens element 210, a second lens element 220, a third lens element 230, a fourth lens element 240 and an image source plane 280, wherein the four-piece infrared single wavelength projection lens system has a total of four lens elements with refractive power. The stop 200 is disposed between an object to be projected and an image source-side surface 212 of the first lens element 210. The four-piece infrared single wavelength projection lens system can project the light on the image source plane 280 of the image source side to the object to be projected on the image side.

The first lens element 210 with a positive refractive power has an image-side surface 211 being convex near an optical axis 290 and the image source-side surface 212 being concave near the optical axis 290, the image-side surface 211 and the image source-side surface 212 are aspheric, and the first lens element 210 is made of glass.

The second lens element 220 with a negative refractive power has an image-side surface 221 being convex near the optical axis 290 and an image source-side surface 222 being concave near the optical axis 290, the image-side surface 221 and the image source-side surface 222 are aspheric, and the second lens element 220 is made of plastic material.

The third lens element 230 with a negative refractive power has an image-side surface 231 being concave near the optical axis 290 and an image source-side surface 232 being concave near the optical axis 290, the image-side surface 231 and the image source-side surface 232 are aspheric, and the third lens element 230 is made of plastic material.

The fourth lens element 240 with a positive refractive power has an image-side surface 241 being convex near the optical axis 290 and an image source-side surface 242 being convex near the optical axis 290, the image-side surface 241 and the image source-side surface 242 are aspheric, and the fourth lens element 240 is made of plastic material.

The detailed optical data of the second embodiment is shown in table 3, and the aspheric surface data is shown in table 4.

TABLE 3
Embodiment 2
F(focal length) = 4 mm, Fno = 2.1, FOV = 26.8 deg.

| | | | | | | | | Focal |
|---|---|---|---|---|---|---|---|---|
| surface | | Curvature Radius | | Thickness | Material | Index | Abbe # | length |
| 0 | object | plane | | 1000 | | | | |
| 1 | | plane | | 0.303 | | | | |
| 2 | stop | plane | | −0.303 | | | | |
| 3 | Lens 1 | 1.370 | (ASP) | 0.639 | glass | 1.81 | 40.7 | 2.87 |
| 4 | | 2.743 | (ASP) | 0.033 | | | | |
| 5 | Lens 2 | 1.920 | (ASP) | 0.685 | plastic | 1.64 | 22.5 | −9.24 |
| 6 | | 1.242 | (ASP) | 0.550 | | | | |
| 7 | Lens 3 | −2.047 | (ASP) | 0.265 | plastic | 1.64 | 22.5 | −1.53 |
| 8 | | 1.861 | (ASP) | 0.302 | | | | |
| 9 | Lens 4 | 2.556 | (ASP) | 1.134 | plastic | 1.64 | 22.5 | 1.70 |
| 10 | | −1.492 | (ASP) | 0.526 | | | | |

| | | |
|---|---|---|
| 11 | Image | plane |
| | source | |
| | plane | |

TABLE 4
Aspheric Coefficients

| surface | 3 | 4 | 5 | 6 |
|---|---|---|---|---|
| K: | −3.3344E−01 | 5.8068E+00 | 2.8158E+00 | −3.2188E+00 |
| A: | 2.8910E−03 | 5.6760E−03 | 6.1333E−02 | 3.2099E−01 |
| B: | 8.1810E−03 | 4.4101E−01 | 5.5181E−01 | 2.2372E−01 |
| C: | 1.7400E−04 | −1.0139E+00 | −9.5500E−01 | 1.9093E+00 |
| D: | 4.5410E−03 | 1.3212E+00 | 1.3268E+00 | −2.8489E+00 |
| E: | −4.6570E−02 | −1.2018E+00 | −1.6863E+00 | 9.8154E+00 |
| F: | 7.0509E−02 | 2.4148E−01 | 1.4069E+00 | 1.3971E+01 |
| G: | −3.7430E−02 | 1.4951E−01 | −7.6622E−01 | −4.7791E+01 |
| surface | 7 | 8 | 9 | 10 |
| K: | 1.1227E+01 | −6.1758E+01 | −1.8594E+01 | −5.3955E−01 |
| A: | −1.2884E+00 | −2.7426E−01 | −1.5721E−01 | −9.7240E−02 |
| B: | 3.9818E+00 | −9.0443E−01 | 1.3389E−01 | 4.6018E−02 |
| C: | −1.2776E+01 | 1.1529E+01 | 6.6133E−02 | −1.1175E−01 |
| D: | 5.9584E+01 | −3.1636E+01 | −2.1743E−01 | 1.2404E−01 |
| E: | −1.7539E+02 | 2.6902E+01 | 2.6438E−01 | −1.0300E−02 |
| F: | 1.8723E+02 | 3.4063E+01 | −1.4169E−01 | −8.3940E−02 |
| G: | 9.4113E+01 | −5.7595E+01 | 2.5144E−02 | 4.5217E−02 |

In the second embodiment, the equation of the aspheric surface profiles of the aforementioned lens elements is the same as the equation of the first embodiment. Also, the definitions of these parameters shown in the following table are the same as those stated in the first embodiment with corresponding values for the second embodiment, so an explanation in this regard will not be provided again.

Moreover, these parameters can be calculated from Table 3 and Table 4 as the following values and satisfy the following conditions:

Embodiment 2

| | | | |
|---|---|---|---|
| f[mm] | 4.01 | f23/f | −0.35 |
| Fno | 2.1 | f2/TL | −2.24 |
| FOV[deg.] | 26.8 | R2/CT1 | 4.29 |
| f2/CT2 | −13.49 | R3/T12 | 58.66 |
| f2/f3 | 6.04 | R6/f3 | −1.22 |
| R7/T34 | 8.47 | R7/f34 | 0.69 |
| f1/f2 | −0.31 | T23/CT3 | 2.08 |
| f3/f4 | −0.90 | T34/CT4 | 0.27 |
| f2/f23 | 6.63 | f/f2 | −0.43 |
| f2/f12 | −3.12 | R2/R6 | 1.47 |
| f1/f34 | 0.78 | R7/CT4 | 2.25 |

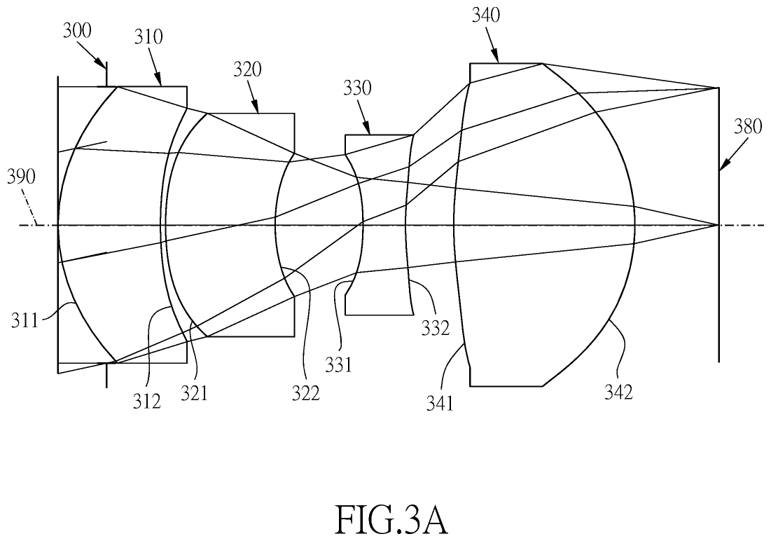

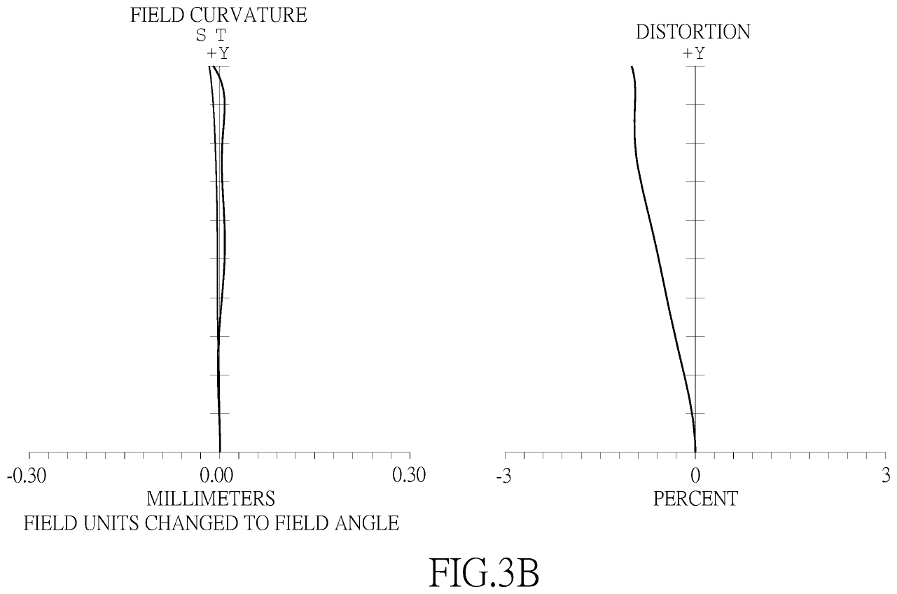

Referring to FIGS. 3A and 3B, FIG. 3A shows a four-piece infrared single wavelength projection lens system in accordance with a third embodiment of the present invention, and FIG. 3B shows, in order from left to right, the image plane curve and the distortion curve of the third embodiment of the present invention. A four-piece infrared single wavelength projection lens system in accordance with the third embodiment of the present invention comprises a stop 300 and a lens group. The lens group comprises, in order from an image side to an image source side: a first lens element 310, a second lens element 320, a third lens element 330, a fourth lens element 340 and an image source plane 380, wherein the four-piece infrared single wavelength projection lens system has a total of four lens elements with refractive power. The stop 300 is disposed between an object to be projected and an image source-side surface 312 of the first lens element 310. The four-piece infrared single wavelength projection lens system can project the light on the image source plane 380 of the image source side to the object to be projected on the image side.

The first lens element 310 with a positive refractive power has an image-side surface 311 being convex near an optical axis 390 and the image source-side surface 312 being concave near the optical axis 390, the image-side surface 311 and the image source-side surface 312 are aspheric, and the first lens element 310 is made of glass.

The second lens element 320 with a negative refractive power has an image-side surface 321 being convex near the optical axis 390 and an image source-side surface 322 being concave near the optical axis 390, the image-side surface 321 and the image source-side surface 322 are aspheric, and the second lens element 320 is made of plastic material.

The third lens element 330 with a negative refractive power has an image-side surface 331 being concave near the optical axis 390 and an image source-side surface 332 being concave near the optical axis 390, the image-side surface 331 and the image source-side surface 332 are aspheric, and the third lens element 330 is made of plastic material.

The fourth lens element 340 with a positive refractive power has an image-side surface 341 being convex near the optical axis 390 and an image source-side surface 342 being convex near the optical axis 390, the image-side surface 341 and the image source-side surface 342 are aspheric, and the fourth lens element 340 is made of plastic material.

The detailed optical data of the third embodiment is shown in table 5, and the aspheric surface data is shown in table 6.

TABLE 5
Embodiment 3
F(focal length) = 4 mm, Fno = 2.2, FOV = 27 deg.

| | | | | | | | | Focal |
|---|---|---|---|---|---|---|---|---|
| surface | | Curvature Radius | | Thickness | Material | Index | Abbe # | length |
| 0 | object | plane | | 1000 | | | | |
| 1 | | plane | | 0.063 | | | | |
| 2 | stop | plane | | −0.063 | | | | |
| 3 | Lens 1 | 1.572 | (ASP) | 0.539 | glass | 1.81 | 40.7 | 2.20 |
| 4 | | 13.895 | (ASP) | 0.021 | | | | |
| 5 | Lens 2 | 2.049 | (ASP) | 0.748 | plastic | 1.64 | 22.5 | −2.74 |
| 6 | | 0.799 | (ASP) | 0.411 | | | | |
| 7 | Lens 3 | −2.170 | (ASP) | 0.238 | plastic | 1.64 | 22.5 | −3.03 |
| 8 | | 14.605 | (ASP) | 0.607 | | | | |
| 9 | Lens 4 | 15.290 | (ASP) | 0.980 | plastic | 1.64 | 22.5 | 2.13 |
| 10 | | −1.414 | (ASP) | 0.520 | | | | |

| | | |
|---|---|---|
| 11 | Image | plane |
| | source | |
| | plane | |

TABLE 6
Aspheric Coefficients

| surface | 3 | 4 | 5 | 6 |
|---|---|---|---|---|
| K: | −6.2978E−01 | 6.0529E+01 | 2.9377E+00 | −2.4574E+00 |
| A: | −2.1189E−02 | 7.5658E−02 | 1.3434E−01 | 4.0116E−01 |
| B: | 9.0220E−03 | 4.0102E−01 | 6.4254E−01 | 3.2606E−01 |
| C: | −8.6680E−03 | −1.0753E+00 | −1.1322E+00 | 6.1583E+00 |
| D: | 6.1510E−03 | 1.2971E+00 | 1.2581E+00 | −7.0837E+00 |
| E: | −4.7291E−02 | −1.0905E+00 | −1.4793E+00 | −2.6386E−01 |
| F: | 6.6602E−02 | 4.6165E−01 | 1.7195E+00 | 1.6642E+02 |
| G: | −4.9807E−02 | −5.3610E−02 | −9.7198E−01 | −1.9413E+02 |
| surface | 7 | 8 | 9 | 10 |
| K: | 1.3477E+01 | −4.8261E+02 | −2.8106E+02 | −7.4645E−01 |
| A: | −1.2435E+00 | −7.8058E−01 | −1.2890E−01 | −1.3544E−01 |
| B: | 1.9114E+00 | 2.0815E+00 | 2.6672E−01 | 1.8502E−01 |
| C: | 4.6842E+00 | 5.6349E+00 | −6.0780E−02 | −2.0219E−01 |
| D: | 2.1219E+01 | −2.9745E+01 | −2.4663E−01 | 1.2111E−01 |
| E: | −2.4852E+02 | 4.0181E+01 | 2.6201E−01 | 6.6400E−03 |
| F: | 6.1439E+02 | 1.0990E+01 | −7.1710E−02 | −6.2350E−02 |
| G: | −4.3580E+02 | −4.9238E+01 | −2.9500E−03 | 3.0276E−02 |

In the third embodiment, the equation of the aspheric surface profiles of the aforementioned lens elements is the same as the equation of the first embodiment. Also, the definitions of these parameters shown in the following table are the same as those stated in the first embodiment with corresponding values for the third embodiment, so an explanation in this regard will not be provided again.

Moreover, these parameters can be calculated from Table 5 and Table 6 as the following values and satisfy the following conditions:

Embodiment 3

| | | | |
|---|---|---|---|
| f[mm] | 4.00 | f23/f | −0.36 |
| Fno | 2.2 | f2/TL | −0.67 |
| FOV[deg.] | 27 | R2/CT1 | 25.76 |
| f2/CT2 | −3.66 | R3/T12 | 98.85 |
| f2/f3 | 0.90 | R6/f3 | −4.83 |
| R7/T34 | 25.17 | R7/f34 | 5.20 |
| f1/f2 | −0.80 | T23/CT3 | 1.73 |
| f3/f4 | −1.42 | T34/CT4 | 0.62 |
| f2/f23 | 1.92 | f/f2 | −1.46 |
| f2/f12 | −0.85 | R2/R6 | 0.95 |
| f1/f34 | 0.75 | R7/CT4 | 15.61 |

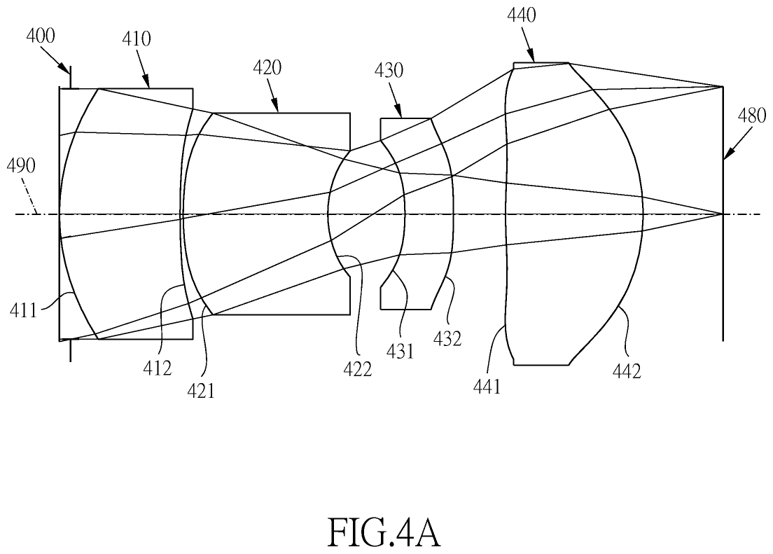

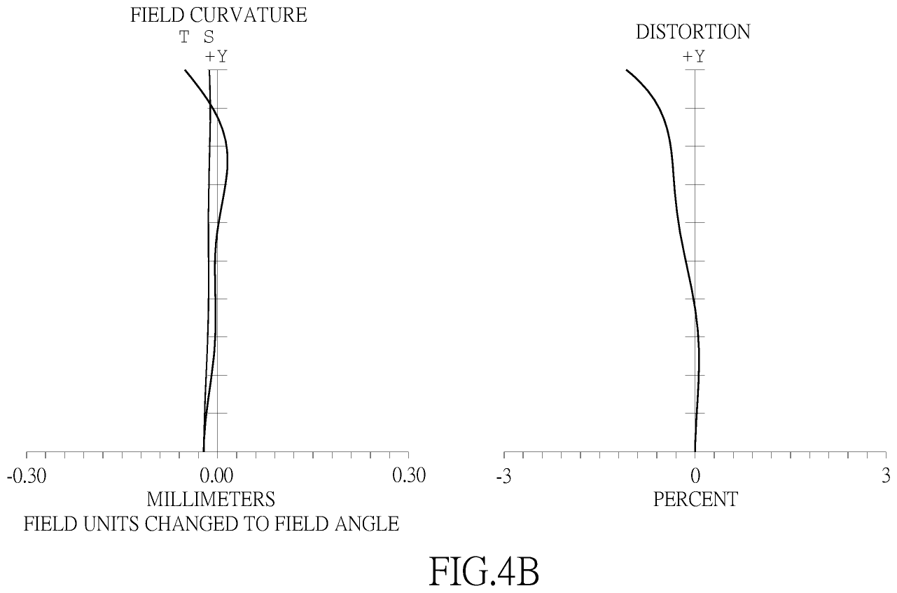

Referring to FIGS. 4A and 4B, FIG. 4A shows a four-piece infrared single wavelength projection lens system in accordance with a fourth embodiment of the present invention, and FIG. 4B shows, in order from left to right, the image plane curve and the distortion curve of the fourth embodiment of the present invention. A four-piece infrared single wavelength projection lens system in accordance with the fourth embodiment of the present invention comprises a stop 400 and a lens group. The lens group comprises, in order from an image side to an image source side: a first lens element 410, a second lens element 420, a third lens element 430, a fourth lens element 440 and an image source plane 480, wherein the four-piece infrared single wavelength projection lens system has a total of four lens elements with refractive power. The stop 400 is disposed between an object to be projected and an image source-side surface 412 of the first lens element 410. The four-piece infrared single wavelength projection lens system can project the light on the image source plane 480 of the image source side to the object to be projected on the image side.

The first lens element 410 with a positive refractive power has an image-side surface 411 being convex near an optical axis 490 and the image source-side surface 412 being concave near the optical axis 490, the image-side surface 411 and the image source-side surface 412 are aspheric, and the first lens element 410 is made of glass.

The second lens element 420 with a negative refractive power has an image-side surface 421 being convex near the optical axis 490 and an image source-side surface 422 being concave near the optical axis 490, the image-side surface 421 and the image source-side surface 422 are aspheric, and the second lens element 420 is made of plastic material.

The third lens element 430 with a negative refractive power has an image-side surface 431 being concave near the optical axis 490 and an image source-side surface 432 being convex near the optical axis 490, the image-side surface 431 and the image source-side surface 432 are aspheric, and the third lens element 430 is made of plastic material.

The fourth lens element 440 with a positive refractive power has an image-side surface 441 being convex near the optical axis 490 and an image source-side surface 442 being convex near the optical axis 490, the image-side surface 441 and the image source-side surface 442 are aspheric, and the fourth lens element 440 is made of plastic material.

The detailed optical data of the fourth embodiment is shown in table 7, and the aspheric surface data is shown in table 8.

TABLE 7
Embodiment 4
F(focal length) = 4 mm, Fno = 2.2, FOV = 26.8 deg.

| | | | | | | | | Focal |
|---|---|---|---|---|---|---|---|---|
| surface | | Curvature Radius | | Thickness | Material | Index | Abbe # | length |
| 0 | object | plane | | 1000 | | | | |
| 1 | | plane | | 0.074 | | | | |
| 2 | stop | plane | | −0.074 | | | | |
| 3 | Lens 1 | 1.753 | (ASP) | 0.800 | glass | 1.81 | 40.7 | 2.65 |
| 4 | | 8.591 | (ASP) | 0.021 | | | | |
| 5 | Lens 2 | 2.543 | (ASP) | 0.957 | plastic | 1.64 | 22.5 | −2.81 |
| 6 | | 0.885 | (ASP) | 0.512 | | | | |
| 7 | Lens 3 | −1.906 | (ASP) | 0.320 | plastic | 1.64 | 22.5 | −3.84 |
| 8 | | −10.147 | (ASP) | 0.345 | | | | |
| 9 | Lens 4 | 3.531 | (ASP) | 0.912 | plastic | 1.64 | 22.5 | 2.04 |
| 10 | | −1.785 | (ASP) | 0.530 | | | | |

| | | |
|---|---|---|
| 11 | Image | plane |
| | source | |
| | plane | |

TABLE 8
Aspheric Coefficients

| surface | 3 | 4 | 5 | 6 |
|---|---|---|---|---|
| K: | −3.5540E−01 | 7.8382E+01 | 3.8333E+00 | −1.5203E+00 |
| A: | −9.8980E−03 | 9.2525E−02 | 1.5743E−01 | 3.6953E−01 |
| B: | 1.1554E−02 | 3.8366E−01 | 5.5153E−01 | −3.8699E−01 |
| C: | −5.1340E−03 | −1.0545E+00 | −1.2512E+00 | 1.0420E+01 |
| D: | 1.6848E−02 | 1.1933E+00 | 1.2702E+00 | −2.0189E+01 |
| E: | −4.7086E−02 | −9.8060E−01 | −1.2409E+00 | −7.3674E+01 |
| F: | 5.0128E−02 | 5.8503E−01 | 1.3680E+00 | 5.1727E+02 |
| G: | −2.1709E−02 | −2.3263E−01 | −8.4825E−01 | −7.5473E+02 |
| surface | 7 | 8 | 9 | 10 |
| K: | 5.6505E+00 | 1.4092E+02 | −3.7461E+01 | −2.3213E−01 |
| A: | −1.3187E+00 | −1.3850E+00 | −4.5739E−01 | −1.9338E−01 |
| B: | 1.9405E+00 | 2.3009E+00 | 5.5058E−01 | 1.8068E−01 |
| C: | −4.0055E+00 | 1.1788E+00 | −6.2620E−02 | −1.7374E−01 |
| D: | 2.6158E+01 | −1.6848E+01 | −2.6597E−01 | 1.1110E−01 |
| E: | −9.0753E+01 | 4.4227E+01 | 2.5489E−01 | 7.8700E−04 |
| F: | 2.1426E+02 | −4.3130E+01 | −1.1406E−01 | −5.0310E−02 |
| G: | −2.1537E+02 | 1.0672E+01 | 2.3211E−02 | 2.7386E−02 |

In the fourth embodiment, the equation of the aspheric surface profiles of the aforementioned lens elements is the same as the equation of the first embodiment. Also, the definitions of these parameters shown in the following table are the same as those stated in the first embodiment with corresponding values for the fourth embodiment, so an explanation in this regard will not be provided again.

Moreover, these parameters can be calculated from Table 7 and Table 8 as the following values and satisfy the following conditions:

Embodiment 4

| | | | |
|---|---|---|---|
| f[mm] | 4.01 | f23/f | −0.40 |
| Fno | 2.2 | f2/TL | −0.64 |
| FOV[deg.] | 26.8 | R2/CT1 | 10.75 |
| f2/CT2 | −2.93 | R3/T12 | 121.37 |
| f2/f3 | 0.73 | R6/f3 | 2.64 |
| R7/T34 | 10.24 | R7/f34 | 1.25 |
| f1/f2 | −0.94 | T23/CT3 | 1.60 |
| f3/f4 | −1.88 | T34/CT4 | 0.38 |
| f2/f23 | 1.75 | f/f2 | −1.43 |
| f2/f12 | −0.71 | R2/R6 | −0.85 |
| f1/f34 | 0.94 | R7/CT4 | 3.87 |

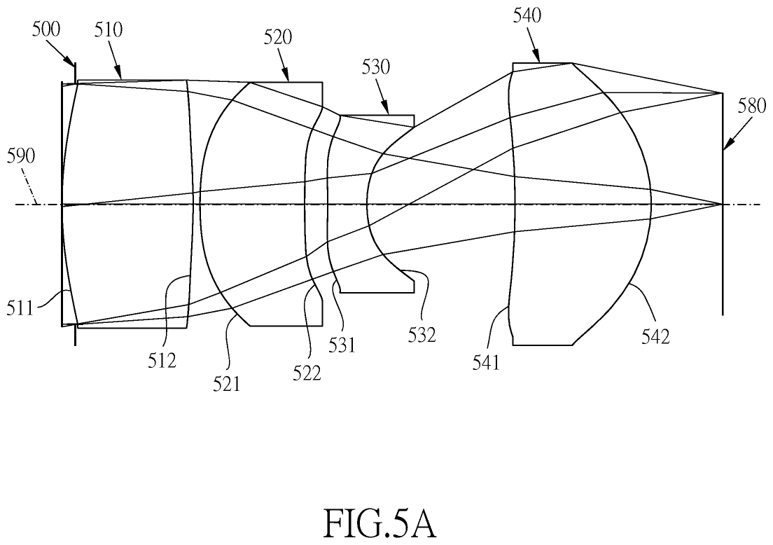

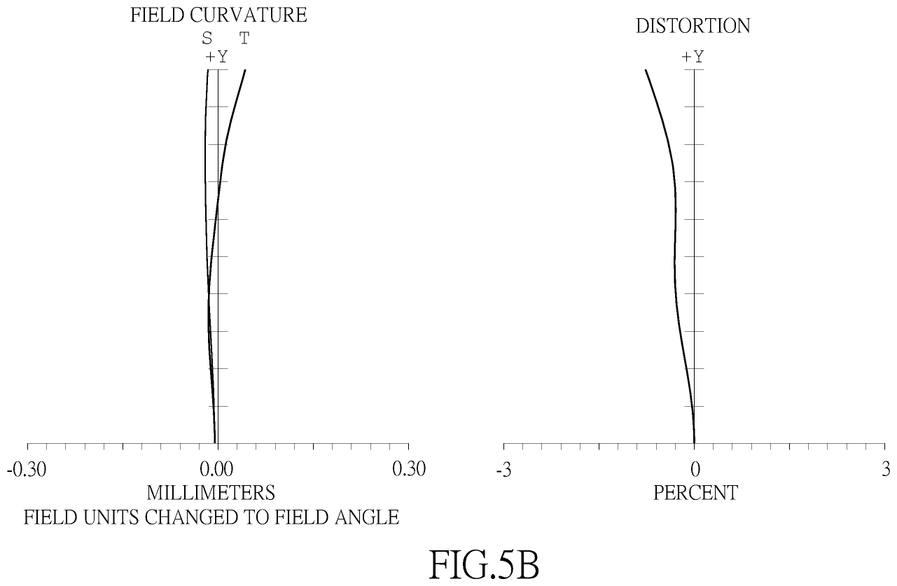

Referring to FIGS. 5A and 5B, FIG. 5A shows a four-piece infrared single wavelength projection lens system in accordance with a fifth embodiment of the present invention, and FIG. 5B shows, in order from left to right, the image plane curve and the distortion curve of the fifth embodiment of the present invention. A four-piece infrared single wavelength projection lens system in accordance with the fifth embodiment of the present invention comprises a stop 500 and a lens group. The lens group comprises, in order from an image side to an image source side: a first lens element 510, a second lens element 520, a third lens element 530, a fourth lens element 540 and an image source plane 580, wherein the four-piece infrared single wavelength projection lens system has a total of four lens elements with refractive power. The stop 500 is disposed between an object to be projected and an image source-side surface 512 of the first lens element 510. The four-piece infrared single wavelength projection lens system can project the light on the image source plane 580 of the image source side to the object to be projected on the image side.

The first lens element 510 with a positive refractive power has an image-side surface 511 being convex near an optical axis 590 and the image source-side surface 512 being convex near the optical axis 590, the image-side surface 511 and the image source-side surface 512 are aspheric, and the first lens element 510 is made of glass.

The second lens element 520 with a positive refractive power has an image-side surface 521 being convex near the optical axis 590 and an image source-side surface 522 being concave near the optical axis 590, the image-side surface 521 and the image source-side surface 522 are aspheric, and the second lens element 520 is made of plastic material.

The third lens element 530 with a negative refractive power has an image-side surface 531 being concave near the optical axis 590 and an image source-side surface 532 being concave near the optical axis 590, the image-side surface 531 and the image source-side surface 532 are aspheric, and the third lens element 530 is made of plastic material.

The fourth lens element 540 with a positive refractive power has an image-side surface 541 being convex near the optical axis 590 and an image source-side surface 542 being convex near the optical axis 590, the image-side surface 541 and the image source-side surface 542 are aspheric, and the fourth lens element 540 is made of plastic material.

The detailed optical data of the fifth embodiment is shown in table 9, and the aspheric surface data is shown in table 10.

TABLE 9
Embodiment 5
F(focal length) = 4.5 mm, Fno = 2.2, FOV = 23.8 deg.

| | | | | | | | | Focal |
|---|---|---|---|---|---|---|---|---|
| surface | | Curvature Radius | | Thickness | Material | Index | Abbe # | length |
| 0 | object | plane | | 1000 | | | | |
| 1 | | plane | | 0.100 | | | | |
| 2 | stop | plane | | −0.100 | | | | |
| 3 | Lens 1 | 3.734 | (ASP) | 0.993 | glass | 1.81 | 40.7 | 2.79 |
| 4 | | −4.758 | (ASP) | 0.051 | | | | |
| 5 | Lens 2 | 3.193 | (ASP) | 0.792 | plastic | 1.64 | 22.5 | 5.69 |
| 6 | | 29.953 | (ASP) | 0.174 | | | | |
| 7 | Lens 3 | −4.021 | (ASP) | 0.296 | plastic | 1.64 | 22.5 | −1.38 |
| 8 | | 1.124 | (ASP) | 1.122 | | | | |
| 9 | Lens 4 | −7.914 | (ASP) | 1.029 | plastic | 1.64 | 22.5 | 2.82 |
| 10 | | −1.503 | (ASP) | 0.541 | | | | |

| | | |
|---|---|---|
| 11 | Image | plane |
| | source | |
| | plane | |

TABLE 10
Aspheric Coefficients

| surface | 3 | 4 | 5 | 6 |
|---|---|---|---|---|
| K: | −3.6401E+00 | −1.2548E+02 | 5.6737E+00 | −5.0027E+02 |
| A: | −2.3183E−02 | 1.7054E−02 | 2.2308E−01 | 2.1599E−01 |
| B: | 3.6255E−02 | 2.6404E−01 | 3.7605E−02 | −2.0571E−02 |
| C: | −3.9820E−02 | −8.6610E−01 | −6.7460E−01 | 5.7636E−01 |
| D: | 1.7492E−02 | 1.2478E+00 | 1.3064E+00 | 1.4081E+00 |
| E: | −1.0584E−02 | −9.9639E−01 | −1.1222E+00 | −1.8865E+00 |
| F: | 1.0006E−02 | 4.2111E−01 | 4.1703E−01 | −5.6328E+00 |
| G: | −3.6324E−03 | −7.2709E−02 | −4.6091E−02 | 5.8294E+00 |
| surface | 7 | 8 | 9 | 10 |
| K: | −4.9508E+02 | 8.4504E−01 | 2.5393E+00 | 3.5095E−01 |
| A: | 5.2250E−01 | 1.3384E+00 | −7.2916E−02 | −7.8944E−02 |
| B: | 1.0700E+00 | −3.7000E+00 | 2.3623E−01 | 2.0390E−01 |
| C: | −9.6154E+00 | 1.6274E+01 | −3.5659E−01 | −2.4897E−01 |
| D: | 4.3192E+01 | −3.4134E+01 | 1.9454E−01 | 1.4618E−01 |
| E: | −1.0371E+02 | 5.9480E+00 | 1.5062E−01 | 1.7861E−02 |
| F: | 1.2250E+02 | 3.7609E+01 | −1.8294E−01 | −6.2987E−02 |
| G: | −6.0145E+01 | −2.3976E+01 | 4.7928E−02 | 2.5490E−02 |

In the fifth embodiment, the equation of the aspheric surface profiles of the aforementioned lens elements is the same as the equation of the first embodiment. Also, the definitions of these parameters shown in the following table are the same as those stated in the first embodiment with corresponding values for the fifth embodiment, so an explanation in this regard will not be provided again.

Moreover, these parameters can be calculated from Table 9 and Table 10 as the following values and satisfy the following conditions:

Embodiment 5

| | | | |
|---|---|---|---|
| f[mm] | 5.00 | f23/f | −0.50 |
| Fno | 2.2 | f2/TL | 1.14 |
| FOV[deg.] | 23.8 | R2/CT1 | −4.79 |
| f2/CT2 | 7.19 | R3/T12 | 62.42 |
| f2/f3 | −4.11 | R6/f3 | −0.81 |
| R7/T34 | −7.05 | R7/f34 | −0.95 |
| f1/f2 | 0.49 | T23/CT3 | 0.59 |
| f3/f4 | −0.49 | T34/CT4 | 1.09 |
| f2/f23 | −2.50 | f/f2 | 0.80 |
| f2/f12 | 2.92 | R2/R6 | −4.23 |
| f1/f34 | 0.33 | R7/CT4 | −7.69 |

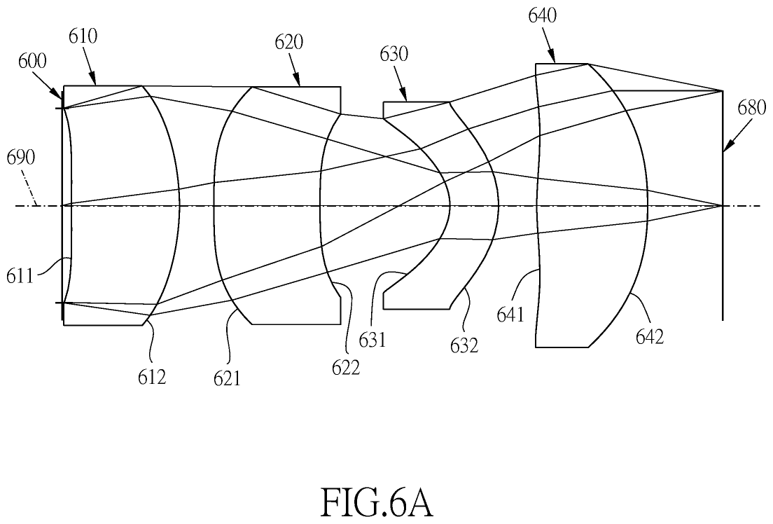

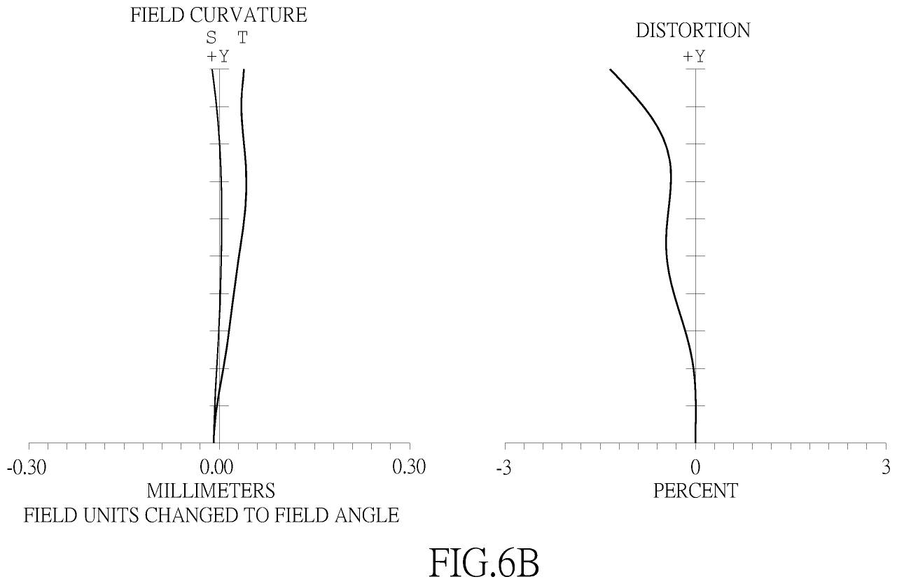

Referring to FIGS. 6A and 6B, FIG. 6A shows a four-piece infrared single wavelength projection lens system in accordance with a sixth embodiment of the present invention, and FIG. 6B shows, in order from left to right, the image plane curve and the distortion curve of the sixth embodiment of the present invention. A four-piece infrared single wavelength projection lens system in accordance with the sixth embodiment of the present invention comprises a stop 600 and a lens group. The lens group comprises, in order from an image side to an image source side: a first lens element 610, a second lens element 620, a third lens element 630, a fourth lens element 640 and an image source plane 680, wherein the four-piece infrared single wavelength projection lens system has a total of four lens elements with refractive power. The stop 600 is disposed between an object to be projected and an image source-side surface 612 of the first lens element 610. The four-piece infrared single wavelength projection lens system can project the light on the image source plane 680 of the image source side to the object to be projected on the image side.

The first lens element 610 with a positive refractive power has an image-side surface 611 being convex near an optical axis 690 and the image source-side surface 612 being convex near the optical axis 690, the image-side surface 611 and the image source-side surface 612 are aspheric, and the first lens element 610 is made of glass.

The second lens element 620 with a negative refractive power has an image-side surface 621 being convex near the optical axis 690 and an image source-side surface 622 being concave near the optical axis 690, the image-side surface 621 and the image source-side surface 622 are aspheric, and the second lens element 620 is made of plastic material.

The third lens element 630 with a negative refractive power has an image-side surface 631 being concave near the optical axis 690 and an image source-side surface 632 being convex near the optical axis 690, the image-side surface 631 and the image source-side surface 632 are aspheric, and the third lens element 630 is made of plastic material.

The fourth lens element 640 with a positive refractive power has an image-side surface 641 being convex near the optical axis 690 and an image source-side surface 642 being convex near the optical axis 690, the image-side surface 641 and the image source-side surface 642 are aspheric, and the fourth lens element 640 is made of plastic material.

The detailed optical data of the sixth embodiment is shown in table 11, and the aspheric surface data is shown in table 12.

TABLE 11
Embodiment 6
F(focal length) = 3.5 mm, Fno = 2.2, FOV = 30.4 deg.

| | | | | | | | | Focal |
|---|---|---|---|---|---|---|---|---|
| surface | | Curvature Radius | | Thickness | Material | Index | Abbe # | length |
| 0 | object | plane | | 1000 | | | | |
| 1 | | plane | | 0.000 | | | | |
| 2 | stop | plane | | 0.068 | | | | |
| 3 | Lens 1 | 38.443 | (ASP) | 0.791 | glass | 1.81 | 40.7 | 2.48 |
| 4 | | −2.045 | (ASP) | 0.251 | | | | |
| 5 | Lens 2 | 20.238 | (ASP) | 0.775 | plastic | 1.64 | 22.5 | −21.59 |
| 6 | | 7.946 | (ASP) | 0.952 | | | | |
| 7 | Lens 3 | −0.495 | (ASP) | 0.356 | plastic | 1.64 | 22.5 | −2.44 |
| 8 | | −0.937 | (ASP) | 0.279 | | | | |
| 9 | Lens 4 | 2.637 | (ASP) | 0.810 | plastic | 1.64 | 22.5 | 2.49 |
| 10 | | −3.291 | (ASP) | 0.551 | | | | |

| | | |
|---|---|---|
| 11 | Image | plane |
| | source | |
| | plane | |

TABLE 12
Aspheric Coefficients

| surface | 3 | 4 | 5 | 6 |
|---|---|---|---|---|
| K: | 8.1166E+00 | −6.3770E+00 | 3.8539E+02 | 1.0457E+02 |
| A: | −1.1821E−01 | −8.2597E−03 | 4.5907E−01 | 4.0008E−01 |
| B: | −2.8849E−02 | −8.4138E−02 | −3.1919E−01 | −3.2633E−01 |
| C: | −5.6583E−02 | −3.8543E−02 | 8.7074E−02 | 1.4065E+00 |
| D: | 7.1934E−02 | 6.8694E−02 | 8.7734E−02 | −4.1039E+00 |
| E: | −1.0161E−01 | −2.6049E−02 | −7.7188E−02 | 5.1545E+00 |
| F: | 1.7419E−02 | −1.1696E−03 | 1.7706E−02 | −2.8308E+00 |
| G: | 0.0000E+00 | 0.0000E+00 | 3.0766E−03 | 6.7721E−02 |
| surface | 7 | 8 | 9 | 10 |
| K: | −6.8510E−01 | −3.8691E−01 | −4.6134E+01 | 5.6540E+00 |
| A: | 5.0053E−01 | −2.2912E−01 | −3.6038E−01 | −3.3253E−01 |
| B: | 3.1206E−01 | 1.1997E+00 | 6.0569E−01 | 5.0793E−01 |
| C: | 2.0043E−02 | −1.4935E+00 | −4.8503E−01 | −3.9378E−01 |
| D: | −2.1115E+00 | 2.8079E−01 | −2.9758E−02 | 8.1893E−02 |
| E: | −1.0025E+01 | 1.0857E+00 | 2.1710E−01 | 4.4893E−02 |
| F: | 4.4318E+01 | −8.5241E−01 | −6.8681E−03 | −5.2700E−03 |
| G: | −3.3769E+01 | 6.1597E−01 | −4.5553E−02 | −6.1100E−03 |

In the sixth embodiment, the equation of the aspheric surface profiles of the aforementioned lens elements is the same as the equation of the first embodiment. Also, the definitions of these parameters shown in the following table are the same as those stated in the first embodiment with corresponding values for the sixth embodiment, so an explanation in this regard will not be provided again.

Moreover, these parameters can be calculated from Table 11 and Table 12 as the following values and satisfy the following conditions:

Embodiment 6

| | | | |
|---|---|---|---|
| f[mm] | 3.53 | f23/f | −0.61 |
| Fno | 2.2 | f2/TL | −4.47 |
| FOV[deg.] | 30.4 | R2/CT1 | −2.59 |
| f2/CT2 | −27.86 | R3/T12 | 80.51 |
| f2/f3 | 8.85 | R6/f3 | 0.38 |
| R7/T34 | 9.45 | R7/f34 | 0.49 |
| f1/f2 | −0.11 | T23/CT3 | 2.68 |
| f3/f4 | −0.98 | T34/CT4 | 0.34 |
| f2/f23 | 9.97 | f/f2 | −0.16 |
| f2/f12 | −8.15 | R2/R6 | 2.18 |
| f1/f34 | 0.46 | R7/CT4 | 3.25 |

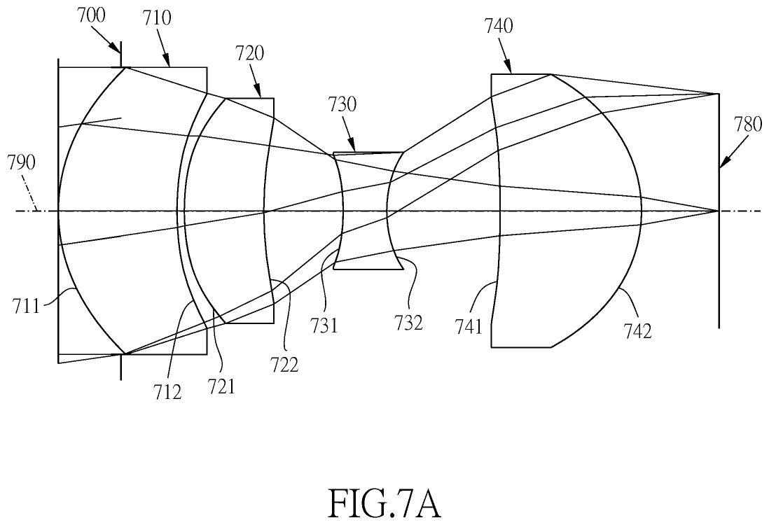

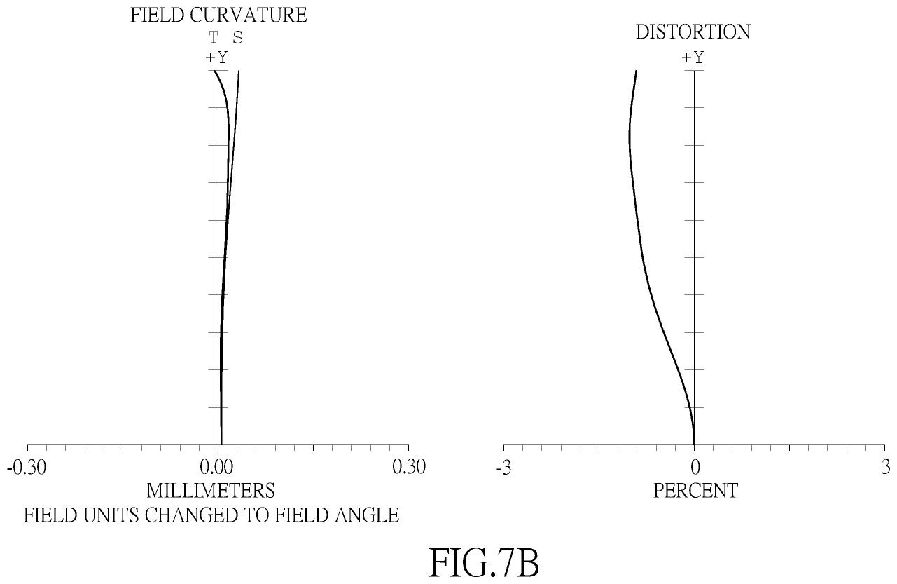

Referring to FIGS. 7A and 7B, FIG. 7A shows a four-piece infrared single wavelength projection lens system in accordance with a seventh embodiment of the present invention, and FIG. 7B shows, in order from left to right, the image plane curve and the distortion curve of the seventh embodiment of the present invention. A four-piece infrared single wavelength projection lens system in accordance with the seventh embodiment of the present invention comprises a stop 700 and a lens group. The lens group comprises, in order from an image side to an image source side: a first lens element 710, a second lens element 720, a third lens element 730, a fourth lens element 740 and an image source plane 780, wherein the four-piece infrared single wavelength projection lens system has a total of four lens elements with refractive power. The stop 700 is disposed between an object to be projected and an image source-side surface 712 of the first lens element 710. The four-piece infrared single wavelength projection lens system can project the light on the image source plane 780 of the image source side to the object to be projected on the image side.

The first lens element 710 with a positive refractive power has an image-side surface 711 being convex near an optical axis 790 and the image source-side surface 712 being concave near the optical axis 790, the image-side surface 711 and the image source-side surface 712 are aspheric, and the first lens element 710 is made of glass.

The second lens element 720 with a positive refractive power has an image-side surface 721 being convex near the optical axis 790 and an image source-side surface 722 being concave near the optical axis 790, the image-side surface 721 and the image source-side surface 722 are aspheric, and the second lens element 720 is made of plastic material.

The third lens element 730 with a negative refractive power has an image-side surface 731 being concave near the optical axis 790 and an image source-side surface 732 being concave near the optical axis 790, the image-side surface 731 and the image source-side surface 732 are aspheric, and the third lens element 730 is made of plastic material.

The fourth lens element 740 with a positive refractive power has an image-side surface 741 being concave near the optical axis 790 and an image source-side surface 742 being convex near the optical axis 790, the image-side surface 741 and the image source-side surface 742 are aspheric, and the fourth lens element 740 is made of plastic material.

The detailed optical data of the seventh embodiment is shown in table 13, and the aspheric surface data is shown in table 14.

TABLE 13
Embodiment 7
F(focal length) = 4.5 mm, Fno = 2.5, FOV = 18.4 deg.

| | | | | | | | | Focal |
|---|---|---|---|---|---|---|---|---|
| surface | | Curvature Radius | | Thickness | Material | Index | Abbe # | length |
| 0 | object | plane | | 1000 | | | | |
| 1 | | plane | | 0.342 | | | | |
| 2 | stop | plane | | −0.342 | | | | |
| 3 | Lens 1 | 1.183 | (ASP) | 0.648 | glass | 1.81 | 40.7 | 2.66 |
| 4 | | 2.068 | (ASP) | 0.040 | | | | |
| 5 | Lens 2 | 1.629 | (ASP) | 0.435 | plastic | 1.64 | 22.5 | 5.77 |
| 6 | | 2.692 | (ASP) | 0.433 | | | | |
| 7 | Lens 3 | −1.455 | (ASP) | 0.238 | plastic | 1.64 | 22.5 | −0.83 |
| 8 | | 0.848 | (ASP) | 0.619 | | | | |
| 9 | Lens 4 | −7.460 | (ASP) | 0.772 | plastic | 1.64 | 22.5 | 1.77 |
| 10 | | −0.993 | (ASP) | 0.423 | | | | |

| | | |
|---|---|---|
| 11 | Image | plane |
| | source | |
| | plane | |

TABLE 14
Aspheric Coefficients

| surface | 3 | 4 | 5 | 6 |
|---|---|---|---|---|
| K: | −3.1459E−01 | 3.4137E+00 | 2.2156E+00 | −1.6092E+01 |
| A: | −1.3215E−02 | 1.4942E−02 | 1.7089E−01 | 1.6754E−01 |
| B: | 1.1461E−01 | 1.7137E+00 | 1.6977E+00 | −9.4829E−01 |
| C: | −3.2973E−01 | −8.7803E+00 | −9.0596E+00 | 6.3286E+00 |
| D: | 5.2692E−01 | 2.1953E+01 | 2.4069E+01 | −2.8139E+01 |
| E: | −4.8141E−01 | −3.2552E+01 | −3.8444E+01 | 6.3606E+01 |
| F: | 1.9142E−01 | 2.5457E+01 | 3.4603E+01 | −8.9237E+01 |
| G: | −2.8344E−02 | −7.8896E+00 | −1.6155E+01 | 5.9795E+01 |
| surface | 7 | 8 | 9 | 10 |
| K: | −2.8829E+01 | 7.3989E−01 | 3.6066E+01 | −8.3148E−01 |
| A: | −1.8372E+00 | 2.5060E−01 | −8.7761E−02 | −3.1303E−01 |
| B: | 6.2960E+00 | −7.1530E−01 | 4.2921E−02 | 7.5655E−01 |
| C: | −7.0227E+01 | 3.6668E+01 | 4.6080E−02 | −2.3294E+00 |
| D: | 6.3716E+02 | −2.5117E+02 | −1.8116E+00 | 2.9673E+00 |
| E: | −3.5516E+03 | 7.1100E+02 | 5.9690E+00 | 5.7452E−02 |
| F: | 1.0188E+04 | 6.3050E+02 | −4.7036E+00 | −4.4373E+00 |
| G: | −1.0622E+04 | −2.5576E+03 | 4.5719E−01 | 3.3142E+00 |

In the seventh embodiment, the equation of the aspheric surface profiles of the aforementioned lens elements is the same as the equation of the first embodiment. Also, the definitions of these parameters shown in the following table are the same as those stated in the first embodiment with corresponding values for the seventh embodiment, so an explanation in this regard will not be provided again.

Moreover, these parameters can be calculated from Table 13 and Table 14 as the following values and satisfy the following conditions:

Embodiment 7

| | | | |
|---|---|---|---|
| f[mm] | 4.50 | f23/f | −0.28 |
| Fno | 2.5 | f2/TL | 1.60 |
| FOV[deg.] | 18.4 | R2/CT1 | 3.19 |
| f2/CT2 | 13.27 | R3/T12 | 40.91 |
| f2/f3 | −6.93 | R6/f3 | −1.02 |
| R7/T34 | −12.05 | R7/f34 | −1.32 |
| f1/f2 | 0.46 | T23/CT3 | 1.82 |
| f3/f4 | −0.47 | T34/CT4 | 0.80 |
| f2/f23 | −4.60 | f/f2 | 0.78 |
| f2/f12 | 3.05 | R2/R6 | 2.44 |
| f1/f34 | 0.47 | R7/CT4 | −9.66 |

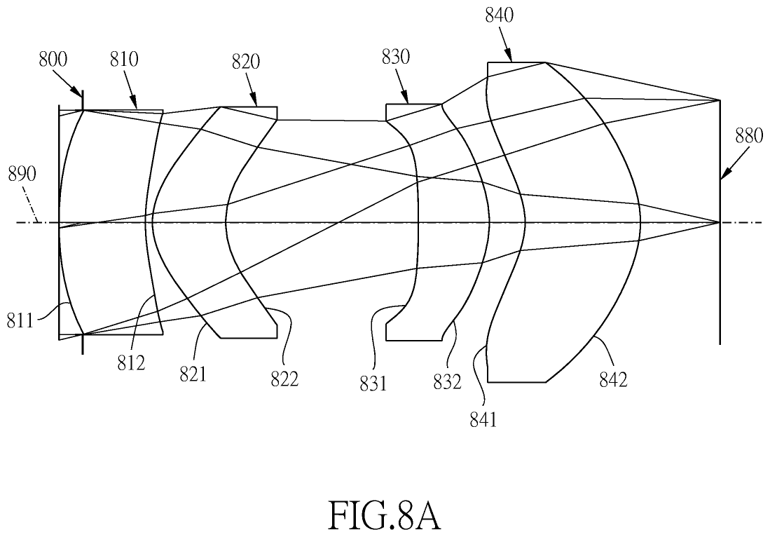

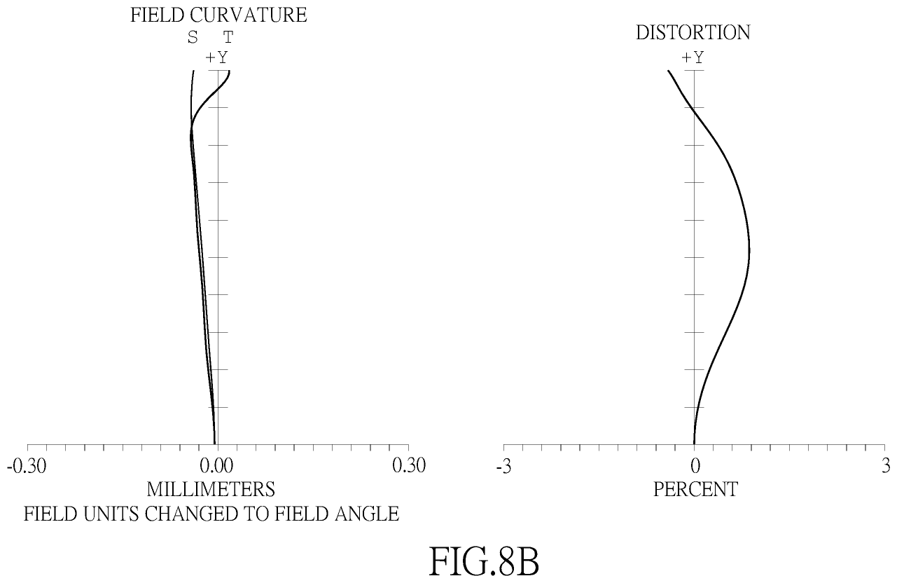

Referring to FIGS. 8A and 8B, FIG. 8A shows a four-piece infrared single wavelength projection lens system in accordance with an eighth embodiment of the present invention, and FIG. 8B shows, in order from left to right, the image plane curve and the distortion curve of the eighth embodiment of the present invention. A four-piece infrared single wavelength projection lens system in accordance with the eighth embodiment of the present invention comprises a stop 800 and a lens group. The lens group comprises, in order from an image side to an image source side: a first lens element 810, a second lens element 820, a third lens element 830, a fourth lens element 840 and an image source plane 880, wherein the four-piece infrared single wavelength projection lens system has a total of four lens elements with refractive power. The stop 800 is disposed between an object to be projected and an image source-side surface 812 of the first lens element 810. The four-piece infrared single wavelength projection lens system can project the light on the image source plane 880 of the image source side to the object to be projected on the image side.

The first lens element 810 with a negative refractive power has an image-side surface 811 being convex near an optical axis 890 and the image source-side surface 812 being concave near the optical axis 890, the image-side surface 811 and the image source-side surface 812 are aspheric, and the first lens element 810 is made of glass.

The second lens element 820 with a positive refractive power has an image-side surface 821 being convex near the optical axis 890 and an image source-side surface 822 being concave near the optical axis 890, the image-side surface 821 and the image source-side surface 822 are aspheric, and the second lens element 820 is made of plastic material.

The third lens element 830 with a positive refractive power has an image-side surface 831 being concave near the optical axis 890 and an image source-side surface 832 being convex near the optical axis 890, the image-side surface 831 and the image source-side surface 832 are aspheric, and the third lens element 830 is made of plastic material.

The fourth lens element 840 with a positive refractive power has an image-side surface 841 being concave near the optical axis 890 and an image source-side surface 842 being convex near the optical axis 890, the image-side surface 841 and the image source-side surface 842 are aspheric, and the fourth lens element 840 is made of plastic material.

The detailed optical data of the eighth embodiment is shown in table 15, and the aspheric surface data is shown in table 16.

TABLE 15
Embodiment 8
F(focal length) = 3.5 mm, Fno = 2.0, FOV = 30 deg.

| | | | | | | | | Focal |
|---|---|---|---|---|---|---|---|---|
| surface | | Curvature Radius | | Thickness | Material | Index | Abbe # | length |
| 0 | object | plane | | 1000 | | | | |
| 1 | | plane | | 0.163 | | | | |
| 2 | stop | plane | | −0.163 | | | | |
| 3 | Lens 1 | 2.994 | (ASP) | 0.594 | glass | 1.69 | 53.2 | −5.09 |
| 4 | | 1.476 | (ASP) | 0.050 | | | | |
| 5 | Lens 2 | 0.588 | (ASP) | 0.505 | plastic | 1.64 | 22.5 | 2.00 |
| 6 | | 0.751 | (ASP) | 1.328 | | | | |
| 7 | Lens 3 | −7.930 | (ASP) | 0.489 | plastic | 1.64 | 22.5 | 1.69 |
| 8 | | −0.948 | (ASP) | 0.247 | | | | |
| 9 | Lens 4 | −0.655 | (ASP) | 0.795 | plastic | 1.64 | 22.5 | 38.72 |
| 10 | | −0.933 | (ASP) | 0.549 | | | | |

| | | |
|---|---|---|
| 11 | Image | plane |
| | source | |
| | plane | |

TABLE 16
Aspheric Coefficients

| surface | 3 | 4 | 5 | 6 |
|---|---|---|---|---|
| K: | 3.3058E+00 | −1.9625E+01 | −2.7480E+00 | −5.5769E−01 |
| A: | 1.0517E−01 | −1.5851E−01 | 2.3196E−01 | 1.7047E−01 |
| B: | −1.3453E−01 | 2.8045E−01 | −1.2064E−01 | −1.4305E+00 |
| C: | 7.0239E−02 | −1.3996E−01 | −5.6067E−01 | 3.2501E−01 |
| D: | 1.0689E−01 | −1.8424E−01 | 2.9869E−01 | 2.2014E+00 |
| E: | −1.7591E−01 | 4.0516E−01 | 8.0180E−01 | −2.4360E+00 |
| F: | 7.9565E−02 | −1.6145E−01 | −5.6641E−01 | 8.6760E−01 |
| G: | 0.0000E+00 | 0.0000E+00 | 0.0000E+00 | 0.0000E+00 |
| surface | 7 | 8 | 9 | 10 |
| K: | 2.7527E+01 | −1.8120E+00 | −3.2308E+00 | −7.9603E−01 |
| A: | −1.0462E−01 | 3.1448E−01 | 3.2576E−01 | 4.3511E−01 |
| B: | −3.0280E−01 | 1.5152E−01 | 5.3474E−01 | −4.9130E−01 |
| C: | 2.5298E−01 | −1.9707E+00 | −4.2020E+00 | 2.2615E−01 |
| D: | −2.9504E+00 | 1.1889E+00 | 8.7596E+00 | 5.3558E−02 |
| E: | 1.4755E−01 | 1.8896E+00 | −8.5682E+00 | −8.0461E−02 |
| F: | 4.9337E+00 | −1.9300E+00 | 4.0901E+00 | 1.2408E−02 |
| G: | −6.9764E−01 | 5.3543E−01 | −7.7081E−01 | 3.4947E−03 |

In the eighth embodiment, the equation of the aspheric surface profiles of the aforementioned lens elements is the same as the equation of the first embodiment. Also, the definitions of these parameters shown in the following table are the same as those stated in the first embodiment with corresponding values for the eighth embodiment, so an explanation in this regard will not be provided again.

Moreover, these parameters can be calculated from Table 15 and Table 16 as the following values and satisfy the following conditions:

Embodiment 8

| | | | |
|---|---|---|---|
| f[mm] | 3.55 | f23/f | 0.69 |
| Fno | 2.0 | f2/TL | 0.44 |
| FOV[deg.] | 30 | R2/CT1 | −2.59 |
| f2/CT2 | 3.96 | R3/T12 | 80.51 |
| f2/f3 | 1.18 | R6/f3 | −0.56 |
| R7/T34 | −2.65 | R7/f34 | −0.28 |
| f1/f2 | −2.54 | T23/CT3 | 2.72 |
| f3/f4 | 0.04 | T34/CT4 | 0.31 |
| f2/f23 | 0.81 | f/f2 | 1.77 |
| f2/f12 | 0.43 | R2/R6 | −1.56 |
| f1/f34 | −2.14 | R7/CT4 | −0.82 |

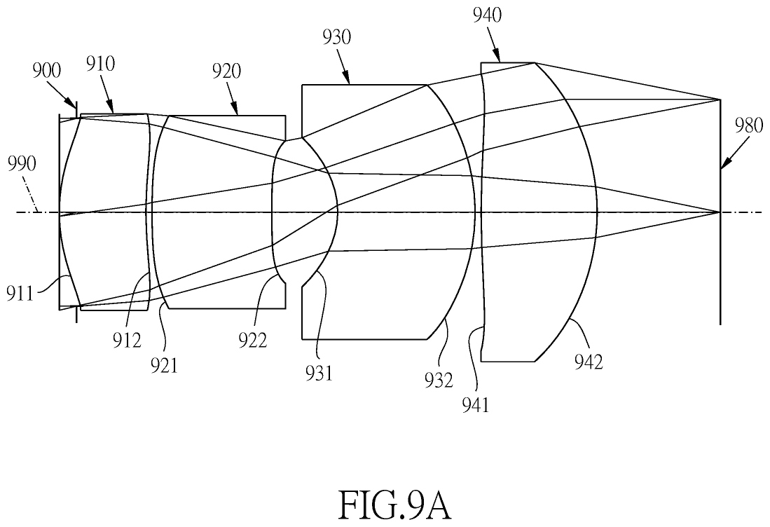

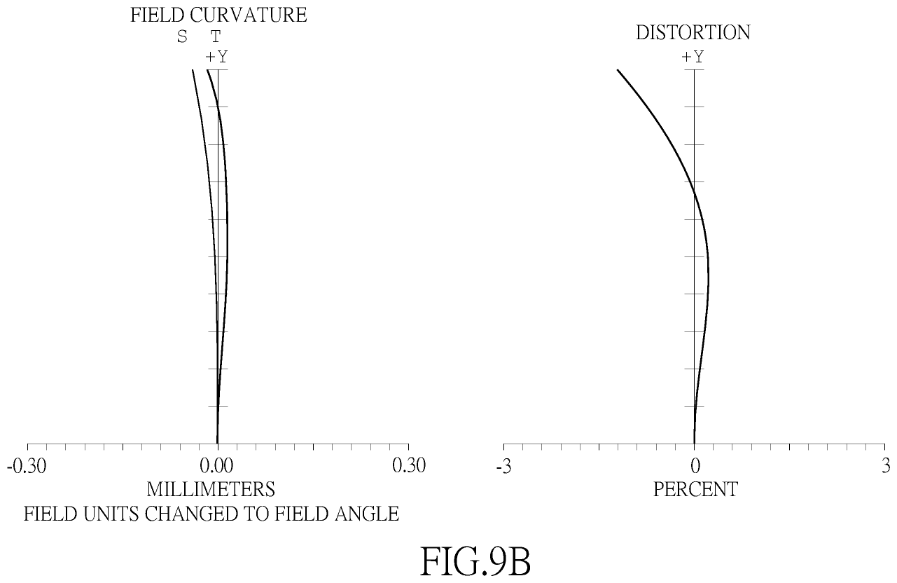

Referring to FIGS. 9A and 9B, FIG. 9A shows a four-piece infrared single wavelength projection lens system in accordance with a ninth embodiment of the present invention, and FIG. 9B shows, in order from left to right, the image plane curve and the distortion curve of the ninth embodiment of the present invention. A four-piece infrared single wavelength projection lens system in accordance with the ninth embodiment of the present invention comprises a stop 900 and a lens group. The lens group comprises, in order from an image side to an image source side: a first lens element 910, a second lens element 920, a third lens element 930, a fourth lens element 940 and an image source plane 980, wherein the four-piece infrared single wavelength projection lens system has a total of four lens elements with refractive power. The stop 900 is disposed between an object to be projected and an image source-side surface 912 of the first lens element 910. The four-piece infrared single wavelength projection lens system can project the light on the image source plane 980 of the image source side to the object to be projected on the image side.

The first lens element 910 with a negative refractive power has an image-side surface 911 being convex near an optical axis 990 and the image source-side surface 912 being concave near the optical axis 990, the image-side surface 911 and the image source-side surface 912 are aspheric, and the first lens element 910 is made of glass.

The second lens element 920 with a positive refractive power has an image-side surface 921 being convex near the optical axis 990 and an image source-side surface 922 being concave near the optical axis 990, the image-side surface 921 and the image source-side surface 922 are aspheric, and the second lens element 920 is made of plastic material.

The third lens element 930 with a positive refractive power has an image-side surface 931 being concave near the optical axis 990 and an image source-side surface 932 being convex near the optical axis 990, the image-side surface 931 and the image source-side surface 932 are aspheric, and the third lens element 930 is made of plastic material.

The fourth lens element 940 with a positive refractive power has an image-side surface 941 being concave near the optical axis 990 and an image source-side surface 942 being convex near the optical axis 990, the image-side surface 941 and the image source-side surface 942 are aspheric, and the fourth lens element 940 is made of plastic material.

The detailed optical data of the ninth embodiment is shown in table 17, and the aspheric surface data is shown in table 18.

TABLE 17
Embodiment 9
F(focal length) = 3.5 mm, Fno = 2.2, FOV = 30.6 deg.

| | | | | | | | | Focal |
|---|---|---|---|---|---|---|---|---|
| surface | | Curvature Radius | | Thickness | Material | Index | Abbe # | length |
| 0 | object | plane | | 1000 | | | | |
| 1 | | plane | | 0.129 | | | | |
| 2 | stop | plane | | −0.129 | | | | |
| 3 | Lens 1 | 1.614 | (ASP) | 0.647 | glass | 1.81 | 40.7 | 3.21 |
| 4 | | 3.643 | (ASP) | 0.046 | | | | |
| 5 | Lens 2 | 6.212 | (ASP) | 0.896 | plastic | 1.64 | 22.5 | 15.04 |
| 6 | | 17.518 | (ASP) | 0.491 | | | | |
| 7 | Lens 3 | −0.801 | (ASP) | 1.027 | plastic | 1.64 | 22.5 | −3.60 |
| 8 | | −1.862 | (ASP) | 0.046 | | | | |
| 9 | Lens 4 | 8.783 | (ASP) | 0.867 | plastic | 1.64 | 22.5 | 2.71 |
| 10 | | −2.008 | (ASP) | 0.921 | | | | |

| | | |
|---|---|---|
| 11 | Image | plane |
| | source | |
| | plane | |

TABLE 18
Aspheric Coefficients

| surface | 3 | 4 | 5 | 6 |
|---|---|---|---|---|
| K: | −1.2753E+00 | −2.1345E+01 | 2.3994E+01 | 5.0164E+02 |
| A: | −2.1781E−02 | −7.2941E−02 | 9.4962E−02 | 3.1301E−01 |
| B: | −7.1296E−02 | −9.9165E−02 | 1.3540E−01 | 6.2880E−01 |
| C: | −2.8918E−02 | −1.5093E−02 | −3.4945E−02 | −5.2652E−01 |
| D: | −3.6263E−02 | 1.4097E−02 | −9.2331E−02 | 2.8626E+00 |
| E: | 0.0000E+00 | 0.0000E+00 | 3.5027E−02 | 4.3704E+00 |
| F: | 0.0000E+00 | 0.0000E+00 | 0.0000E+00 | 0.0000E+00 |
| G: | 0.0000E+00 | 0.0000E+00 | 0.0000E+00 | 0.0000E+00 |
| surface | 7 | 8 | 9 | 10 |
| K: | 2.4556E−01 | 1.0189E+00 | −2.7604E+01 | −4.2410E−02 |
| A: | 1.4699E−01 | 1.1708E−02 | −2.5292E−02 | 2.2172E−02 |
| B: | 6.8373E−01 | 1.9194E−02 | −3.7556E−03 | −3.8139E−02 |
| C: | −8.2385E−01 | 2.8486E−02 | −3.4957E−03 | 1.5435E−02 |
| D: | 2.4467E+00 | −3.8142E−02 | 6.2142E−03 | 5.6850E−04 |
| E: | −4.8163E−01 | 6.0145E−03 | −4.9761E−03 | −2.0461E−03 |
| F: | 0.0000E+00 | 0.0000E+00 | 0.0000E+00 | 0.0000E+00 |
| G: | 0.0000E+00 | 0.0000E+00 | 0.0000E+00 | 0.0000E+00 |

In the ninth embodiment, the equation of the aspheric surface profiles of the aforementioned lens elements is the same as the equation of the first embodiment. Also, the definitions of these parameters shown in the following table are the same as those stated in the first embodiment with corresponding values for the ninth embodiment, so an explanation in this regard will not be provided again.

Moreover, these parameters can be calculated from Table 17 and Table 18 as the following values and satisfy the following conditions:

Embodiment 9

| | | | |
|---|---|---|---|
| f[mm] | 3.51 | f23/f | −1.41 |
| Fno | 2.2 | f2/TL | 3.04 |
| FOV[deg.] | 30.6 | R2/CT1 | 5.63 |
| f2/CT2 | 16.79 | R3/T12 | 135.05 |
| f2/f3 | −4.18 | R6/f3 | 0.52 |
| R7/T34 | 190.96 | R7/f34 | 2.83 |
| f1/f2 | 0.21 | T23/CT3 | 0.48 |
| f3/f4 | −1.32 | T34/CT4 | 0.05 |
| f2/f23 | −3.03 | f/f2 | 0.23 |
| f2/f12 | 5.58 | R2/R6 | −1.96 |
| f1/f34 | 1.03 | R7/CT4 | 10.14 |

In the present four-piece infrared single wavelength projection lens system, the lens elements can be made of plastic or glass. If the lens elements are made of plastic, the cost will be effectively reduced. If the lens elements are made of glass, there is more freedom in distributing the refractive power of the four-piece infrared single wavelength projection lens system and the overall effect of ambient temperature on the lens elements can be reduced. Plastic lens elements can have aspheric surfaces, which allow more design parameter freedom (than spherical surfaces), so as to reduce the aberration and the number of the lens elements, as well as the total track length of the four-piece infrared single wavelength projection lens system.

In the present four-piece infrared single wavelength projection lens system, if the image-side or the image source-side surface of the lens elements with refractive power is convex and the location of the convex surface is not defined, the image-side or the image source-side surface of the lens elements near the optical axis is convex. If the image-side or the image source-side surface of the lens elements is concave and the location of the concave surface is not defined, the image-side or the image source-side surface of the lens elements near the optical axis is concave.

The four-piece infrared single wavelength projection lens system of the present invention can be used in focusing optical systems and can obtain better image quality. The four-piece infrared single wavelength projection lens system of the present invention can also be used in electronic imaging systems, such as, 3D image capturing, digital camera, mobile device, digital flat panel or vehicle camera.

While we have shown and described various embodiments in accordance with the present invention, it should be clear to those skilled in the art that further embodiments may be made without departing from the scope of the present invention.

What is claimed is:

1. A four-piece infrared single wavelength projection lens system, comprising a stop and a lens group having four lens elements, in order from an image side to an image source side:
the stop;
a first lens element with a refractive power, having an image-side surface being convex near an optical axis, at least one of the image-side surface and an image source-side surface of the first lens element being aspheric, the first lens element being made of glass;
a second lens element with a refractive power, having an image-side surface being convex near the optical axis and an image source-side surface being concave near the optical axis, at least one of the image-side surface and the image source-side surface of the second lens element being aspheric;
a third lens element with a refractive power, having an image-side surface being concave near the optical axis, at least one of the image-side surface and an image source-side surface of the third lens element being aspheric; and
a fourth lens element with a positive refractive power, having an image source-side surface being convex near the optical axis, at least one of an image-side surface and the image source-side surface of the fourth lens element being aspheric;
wherein a focal length of the second lens element is f2, a central thickness of the second lens element along the optical axis is CT2, and they satisfy the relation: −28<f2/CT2<161.

2. The four-piece infrared single wavelength projection lens system as claimed in claim 1, wherein the focal length of the second lens element is f2, a focal length of the third lens element is f3, and they satisfy the relation: −45<f2/f3<10.

3. The four-piece infrared single wavelength projection lens system as claimed in claim 1, wherein a radius of curvature of the image-side surface of the fourth lens element is R7, a distance along the optical axis between the third lens element and the fourth lens element is T34, and they satisfy the relation: −63<R7/T34<192.

4. The four-piece infrared single wavelength projection lens system as claimed in claim 1, wherein the four-piece infrared single wavelength projection lens system has a maximum view angle (field of view) FOV, and it satisfies the relation: FOV<36.

5. The four-piece infrared single wavelength projection lens system as claimed in claim 1, wherein a focal length of the first lens element is f1, the focal length of the second lens element is f2, and they satisfy the relation: −3<f1/f2<1.

6. The four-piece infrared single wavelength projection lens system as claimed in claim 1, wherein a focal length of the third lens element is f3, a focal length of the fourth lens element is f4, and they satisfy the relation: −2<f3/f4<0.1.

7. The four-piece infrared single wavelength projection lens system as claimed in claim 1, wherein the focal length of the second lens element is f2, a focal length of the second lens element and the third lens element combined is f23, and they satisfy the relation: −38<f2/f23<10.

8. The four-piece infrared single wavelength projection lens system as claimed in claim 1, wherein the focal length of the second lens element is f2, a focal length of the first lens element and the second lens element combined is f12, and they satisfy the relation: −8.5<f2/f12<32.

9. The four-piece infrared single wavelength projection lens system as claimed in claim 1, wherein a focal length of the first lens element is f1, a focal length of the third lens element and the fourth lens element combined is f34, and they satisfy the relation: −2.2<f1/f34<1.1.

10. The four-piece infrared single wavelength projection lens system as claimed in claim 1, wherein a focal length of the second lens element and the third lens element combined is f23, a focal length of the four-piece infrared single wavelength projection lens system is f, and they satisfy the relation: −1.5<f23/f<0.75.

11. The four-piece infrared single wavelength projection lens system as claimed in claim 1, wherein the focal length of the second lens element is f2, a distance from the image-side surface of the first lens element to an image source plane along the optical axis is TL, and they satisfy the relation: −5<f2/TL<21.

12. The four-piece infrared single wavelength projection lens system as claimed in claim 1, wherein a radius of curvature of the image source-side surface of the first lens element is R2, a central thickness of the first lens element along the optical axis is CT1, and they satisfy the relation: −5<R2/CT1<26.

13. The four-piece infrared single wavelength projection lens system as claimed in claim 1, wherein a radius of curvature of the image-side surface of the second lens element is R3, a distance along the optical axis between the first lens element and the second lens element is T12, and they satisfy the relation: 40<R3/T12<136.

14. The four-piece infrared single wavelength projection lens system as claimed in claim 1, wherein a radius of curvature of the image source-side surface of the third lens element is R6, a focal length of the third lens element is f3, and they satisfy the relation: −5<R6/f3<3.

15. The four-piece infrared single wavelength projection lens system as claimed in claim 1, wherein a radius of curvature of the image-side surface of the fourth lens element is R7, a focal length of the third lens element and the fourth lens element combined is f34, and they satisfy the relation: −10<R7/f34<5.5.

16. The four-piece infrared single wavelength projection lens system as claimed in claim 1, wherein a distance along the optical axis between the second lens element and the third lens element is T23, a central thickness of the third lens element along the optical axis is CT3, and they satisfy the relation: 0.4<T23/CT3<2 0.8.

17. The four-piece infrared single wavelength projection lens system as claimed in claim 1, wherein a distance along the optical axis between the third lens element and the fourth lens element is T34, a central thickness of the fourth lens element along the optical axis is CT4, and they satisfy the relation: 0.04<T34/CT4<1.1.

18. The four-piece infrared single wavelength projection lens system as claimed in claim 1, wherein a focal length of the four-piece infrared single wavelength projection lens system is f, the focal length of the second lens element is f2, and they satisfy the relation: −1.5<f/f2<1.9.

19. The four-piece infrared single wavelength projection lens system as claimed in claim 1, wherein a radius of curvature of the image source-side surface of the first lens element is R2, a radius of curvature of the image source-side surface of the third lens element is R6, and they satisfy the relation: −5<R2/R6<2.5.

20. The four-piece infrared single wavelength projection lens system as claimed in claim 1, wherein a radius of curvature of the image-side surface of the fourth lens element is R7, a central thickness of the fourth lens element along the optical axis is CT4, and they satisfy the relation: −32<R7/CT4<17.
